(19) United States
(12) Patent Application Publication
(10) Pub. No.: US 2026/0180645 A1
(43) Pub. Date: Jun. 25, 2026

(54) CODEBOOK CONFIGURATION FOR CHANNEL STATE INFORMATION (CSI)

(71) Applicant: Lenovo (United States) Inc., Morrisville, NC (US)

(72) Inventor: Ahmed Hindy, Aurora, IL (US)

(73) Assignee: Lenovo (United States) Inc., Morrisville, NC (US)

(21) Appl. No.: 18/988,173

(22) Filed: Dec. 19, 2024

(51) Int. Cl. H04B 7/06; H04B 7/0456; H04L 27/26

(52) U.S. Cl. CPC H04B 7/0626; H04B 7/0456; H04L 27/263

(57) ABSTRACT

Various aspects of the present disclosure relate to codebook configuration for channel state information (CSI). A user equipment (UE) receives CSI configuration including a codebook configuration for precoder matrix indicator (PMI) reporting, where the codebook configuration includes a codebook type and the codebook type includes a set of parameters identifying at least one of a first transformation of a spatial domain, a second transformation of a frequency domain, or a third transformation of a time domain. The UE measures CSI based at least in part on one or more received reference signals (RSs), and transmits a CSI report including a set of CSI parameters, where the set of CSI parameters are based at least in part on the measured CSI and the CSI configuration, and the set of CSI parameters indicate at least one of the first transformation, the second transformation, or the third transformation.

### TECHNICAL FIELD

The present disclosure relates to wireless communications, and more specifically to channel state information (CSI) in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive CSI configuration including a codebook configuration for precoding matrix indicator (PMI) reporting, where the codebook configuration includes a codebook type and the codebook type includes a set of parameters identifying at least one of a first transformation of a spatial domain, a second transformation of a frequency domain, or a third transformation of a time domain; measure CSI based at least in part on one or more received reference signals (RSs); and transmit a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain.

A processor (e.g., a standalone processor chipset, or a component of a UE) for wireless communication is described. The processor may be configured to, capable of, or operable to perform one or more operations as described herein. For example, the processor may be configured to, capable of, or operable to receive CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; measure CSI based at least in part on one or more received RSs; and transmit a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain.

A method performed or performable by a UE for wireless communication is described. The method may include receiving CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; measuring CSI based at least in part on one or more received RSs; and transmitting a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain.

In some implementations of the UE, the processor, and the method described herein, where the first transformation is based on at least one of: a first subset of columns of a first discrete Fourier transform (DFT) matrix; a zero-forcing precoder that minimizes interference at the UE of a signal from a NE intended for another UE; a Hadamard transformation; a trivial selection of a subset of antenna ports; or a transformation corresponding to distinct precoder coefficient values for individual antenna ports.

In some implementations of the UE, the processor, and the method described herein, the second transformation is based on at least one of: a second subset of columns of a second DFT matrix; a one-to-one transformation corresponding to a distinct precoder for each subband in the frequency domain; a many-to-one transformation corresponding to a distinct precoder coefficient for each group of multiple groups of contiguous subbands in the frequency domain; a trivial transformation corresponding to a wideband precoder coefficient that is common for all subbands in a bandwidth part; a transformation based on a power-delay profile of a channel associated with the UE and a NE; a discrete cosine transform; or a discrete wavelet transform.

In some implementations of the UE, the processor, and the method described herein, the third transformation is based on at least one of: a third subset of columns of a third DFT matrix; a one-to-one transformation corresponding to a distinct precoder coefficient for each slot in the time domain; a many-to-one transformation corresponding to a distinct precoder coefficient for each group of multiple groups of contiguous slots; a Bessel function-based transform; a discrete cosine transform; or a discrete wavelet transform.

In some implementations of the UE, the processor, and the method described herein, the second transformation and the third transformation are implemented jointly as a single transformation.

In some implementations of the UE, the processor, and the method described herein, the set of CSI parameters further include an indication of a set of precoder coefficients based on one or more of: a first transformed domain based on the first transformation; a second transformed domain based on the second transformation; a third transformed domain based on the third transformation; or an indication of a subset of precoder coefficients in the set of precoder coefficients with non-zero amplitude values.

In some implementations of the UE, the processor, and the method described herein, the codebook type corresponds to a Fourier-based codebook type.

In some implementations of the UE, the processor, and the method described herein, the first transformation is based on a first subset of columns of a first DFT matrix; and the second transformation is based on a combination of a second subset of columns of a second DFT matrix, where a distinct precoder for each group of multiple groups of contiguous subbands in the frequency domain is applied.

In some implementations of the UE, the processor, and the method described herein, the third transformation is based on at least one of: a third subset of columns of a third DFT matrix; a one-to-one transformation corresponding to a distinct precoder for each slot in the time domain; or a many-to-one transformation corresponding to a distinct precoder for each group of multiple groups of contiguous slots.

In some implementations of the UE, the processor, and the method described herein, the codebook type corresponds to a singular value decomposition (SVD)-based codebook type.

In some implementations of the UE, the processor, and the method described herein, the first transformation is based on a trivial transformation corresponding to a distinct precoder coefficient for individual antenna ports based on an SVD of a corresponding channel matrix; the second transformation is based on a many-to-one transformation corresponding to a distinct precoder coefficient for each group of multiple groups of contiguous subbands in the frequency domain; and the third transformation is based on a many-to-one transformation corresponding to a distinct precoder coefficient for each group of multiple groups of contiguous slots.

In some implementations of the UE, the processor, and the method described herein, the one or more received RSs include non-zero power (NZP) CSI-RSs configured for channel measurement.

In some implementations of the UE, the processor, and the method described herein, the codebook type corresponds to a covariance-based codebook type.

In some implementations of the UE, the processor, and the method described herein, the covariance-based codebook type corresponds to one or more of interference or noise measured at the UE.

In some implementations of the UE, the processor, and the method described herein, the one or more received RSs include one or more of: NZP CSI-RSs configured for interference measurement; or zero power (ZP) CSI-RSs configured for interference measurement.

In some implementations of the UE, the processor, and the method described herein, the set of CSI parameters include one or more of: identification of a subset of precoder coefficients with non-zero amplitude values from a set of coefficients; or amplitude values and phase values corresponding to the subset of precoder coefficients.

In some implementations of the UE, the processor, and the method described herein, the covariance-based codebook type corresponds to a measure of an autocorrelation of a channel in one or more of the time domain, Doppler domain, the frequency domain, delay domain, or the spatial domain.

An NE (e.g., a base station) for wireless communication is described. The NE may be configured to, capable of, or operable to perform one or more operations as described herein. For example, the NE may be configured to, capable of, or operable to transmit CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; and receive a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain.

A processor (e.g., a standalone processor chipset, or a component of a NE) for wireless communication is described. The processor may be configured to, capable of, or operable to perform one or more operations as described herein. For example, the processor may be configured to, capable of, or operable to transmit CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; and receive a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain.

A method performed or performable by an NE (e.g., a base station) for wireless communication is described. The method may include transmitting CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; and receiving a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain.

### BRIEF DESCRIPTION OF THE DRAWINGS

FIG. 1 illustrates an example of a wireless communications system in accordance with aspects of the present disclosure.

FIG. 2 illustrates a scenario for aperiodic trigger state defining a list of CSI report settings.

FIG. 3 illustrates aperiodic trigger state indicating a resource set and quasi co-location (QCL) information.

FIG. 4 illustrates radio resource control (RRC) configuration for NZP-CSI-RS.

FIG. 5 illustrates RRC configuration for CSI-interference management (IM) resources.

FIG. 6 illustrates a scenario for partial CSI omission.

FIG. 7 illustrates example information element for configuring an NZP-CSI-RS resource set.

FIG. 8 illustrates an example tracking reference signal (TRS) configuration.

FIG. 9 illustrates an example information element.

FIG. 10 illustrates an example information element.

FIG. 11 illustrates an example information element.

FIGS. 12 and 13 illustrate an example of demodulation reference signal (DMRS) patterns for mapping Type A with front-load DMRS.

FIG. 14 illustrates an example schematic for a CSI framework in accordance with aspects of the present disclosure.

FIG. 15 illustrates an example of a UE in accordance with aspects of the present disclosure.

FIG. 16 illustrates an example of a processor in accordance with aspects of the present disclosure.

FIG. 17 illustrates an example of an NE in accordance with aspects of the present disclosure.

FIG. 18 illustrates a flowchart of a method in accordance with aspects of the present disclosure.

FIG. 19 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In utilizing time-frequency resources, the UE and/or the NE may utilize a CSI to optimize wireless channels between NEs and UEs. The UE, for instance, can transmit CSI to the NE and the CSI can include data describing different wireless channel parameters, such channel quality of a wireless channel between the NE and the UE, a PMI including information about a precoding matrix for data transmission, a RI indicating a number of transmission layers, etc. In some wireless communications systems, a UE may report a CSI feedback to an NE in various forms. For instance, the CSI feedback may be reported in accordance with CSI format, frequency granularity, and temporal periodic/non-periodic reporting. A CSI report reported (e.g., transmitted) by a UE, for example, can include beam management and PMI feedback. In addition to CSI measurement and reporting for point-to-point scenarios, some wireless communications systems can support CSI frameworks for multi-transmission reception point (TRP)/panel transmission, mobility, and channel synchronization for signaling pre-compensation. In some scenarios, additional enhancements including event-triggered CSI reporting and CSI enhancements for a large number of antennas have been considered.

In some cases, a wireless communications system may support a CSI framework with different modes, such as for point-to-point communication, multi-TRP/panel communication, mobility and channel correlation, etc. In such cases, a wireless communications device (e.g., a UE) may implement each of these modes independently with a different set of CSI measurement and reporting procedures. Supporting different independent CSI modes, however, can result in a large number of CSI processing units and thus the complexity incurred to measure CSI in such systems can be very large, which may result in limiting the network capability to support flexible transmission modes, and/or cause a UE to incur a large computational complexity to enable network flexibility.

In some instances, a wireless communications system may implement mobility mechanisms that can be limited to reference signal received power (RSRP)-based measurement for cell switching decisions, whereas in other instances more complex CSI feedback for mobility (e.g., whether to maintain a current cell or switch to a target cell from a candidate list of target cells) may be implemented. To avoid excess CSI feedback complexity, mobility procedures may be implemented with coarse CSI measurement without robust assessment of QoS after cell switching.

In some cases, a wireless communications system may support PMI codebook designs that include two classes of DFT-based codebook types with low-resolution codebook types and high-resolution codebook types. Using DFT-based codebooks, however, can limit precoding resolution and limit flexibility in supporting different resolutions of spatial-domain compression, frequency-domain compression, and time-domain compression, or no compression at all per respective domain, based on the channel characteristics as well as available computational resources at a UE for CSI measurement and uplink (UL) resources for CSI feedback.

Aspects of the present disclosure are described in the context of a wireless communications system, and include implementations that provide a CSI framework that represents solutions for multiple usage values including beam selection, CSI feedback for flexible rank values, multi-TRP, mobility, channel synchronization, and channel/interference covariance reporting. For example, the described CSI framework categorizes different signaling modes (e.g., signaling hypotheses) into multiple usage scenarios, where each usage scenario can be associated with a different transmission scheme and/or measurement type associated with a UE. Implementations also provide CSI triggering approaches, where a CSI report configuration may include an indication of a CSI measurement. Additionally, a triggering message may indicate a usage value (e.g., CSI usage case). Implementations also support a Layer 1 (L1) mobility approach that enables switching a UE to a new target cell from a set of candidate cells with concise measurement and reporting resources. Implementations also provide a class of codebook types that enables a flexible framework with respect to channel transformation in time domain, frequency domain, and spatial domain, as well as higher-resolution codebook types for UEs with ultra-high QoS constraints.

By performing the described techniques, a wireless communications system can increase efficiency for configuring CSI reporting and generating CSI reports for a variety of different CSI usage cases, which can reduce signaling overhead and resource usage at both NE and UE.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

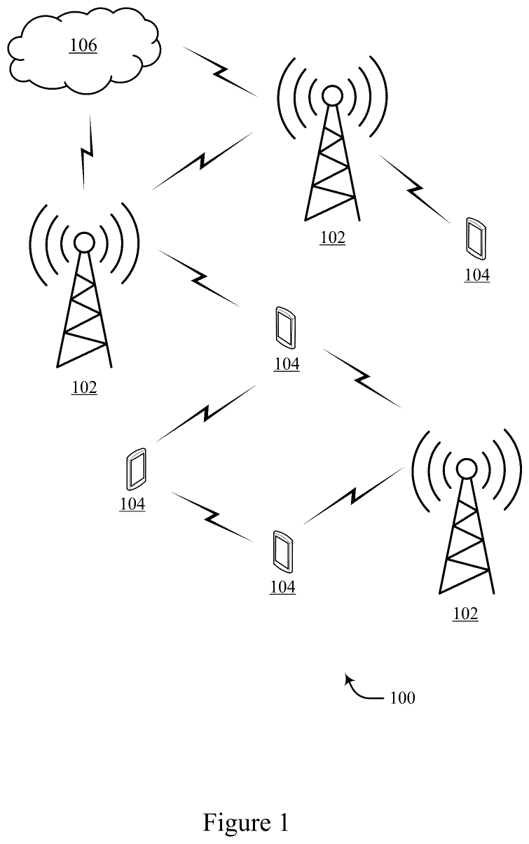

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain. The UE 104 measures CSI based at least in part on one or more received RSs; and transmits a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain.

An NE 102 (e.g., a base station, gNB) transmits CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain. The NE 102 receives a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

The following provides a summary of NR codebook types and additional details can be found in 3GPP Technical Specification (TS) 38.214, “Physical layer procedures for data,” December 2022, hereinafter referenced as [1]. For NR Rel. 15 Type-II codebook, the gNB is equipped with a two-dimensional (2D) antenna array with N₁N₂ antenna ports per polarization (N₁ being the horizontal and N₂ the vertical dimension of the array). In the frequency domain, communication occurs over N₃ PMI sub-bands, where a sub-band includes a set of resource blocks (RBs), each RB including a set of subcarriers. Considering dual-polarization, there are 2N₁N₂ CSI-reference signal (RS) ports that are utilized to enable downlink (DL) channel estimation with high resolution for NR Rel. 15 Type-II codebook. In order to reduce feedback overhead in UL, a DFT-based transformation is used to project the channel onto L spatial beams (shared by both polarizations) where L<N₁N₂. In the sequel, the indices of the L beams are referred as the spatial domain (SD) basis indices. The magnitude and phase values of the 2L linear combination coefficients for each sub-band are fed back to the gNB as part of the CSI report. The 2N₁N₂×N₃ codebook per layer/takes on the form

$${W}_{l} = {W}_{1} {W}_{2 , l} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$$\begin{matrix}{u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L} , {m}_{L - 1}} ]\end{matrix} , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,\end{matrix}$$

where the superscript^{T} denotes a matrix transposition operation. It is to be noted that O₁, O₂ are “oversampling factors”, assumed for the 2D DFT matrix from which matrix B is drawn. Additionally, W₁ is common across all layers. W_{2,l} is a 2L×N₃ matrix, where the i^{th} column corresponds to the linear combination coefficients of the 2L beams in the i^{th} sub-band. The indices of the L selected columns in B are reported, along with the oversampling index taking on 0102 values. It is to be noted that W_{2,l} are independent across different layers.

For NR Rel. 15 Type-II Port Selection Codebook, K (where K≤2N₁N₂) beamformed CSI-RS ports are utilized in DL transmission, in order to reduce complexity. The K×N₃ codebook matrix per layer takes on the form

$${W}_{l} = {W}_{1}^{PS} {W}_{2 , l} .$$

Here, W_{2,l} follows the same structure as the conventional NR Rel. 15 Type-II Codebook and are layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ {e}_{mod ( {m}_{PS} {d}_{PS} , K / 2 )}^{( K / 2 )} \qquad {e}_{mod ( {m}_{PS} {d}_{PS} + 1 , K / 2 )}^{( K / 2 )} \qquad … \qquad {e}_{mod ( {m}_{PS} {d}_{PS} + L - 1 , K / 2 )}^{( K / 2 )} ] ,$$

where

$${e}_{i}^{( K )}$$

is a standard unit vector with a 1 at the i^{th} location. Here d_{PS} is a radio resource control (RRC) parameter which takes on the values {1, 2, 3, 4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback report.

$${W}_{1}^{PS}$$

is common across all layers.

For K=16, L=4 and d_{PS}=1, the 8 possible realizations of E corresponding to m_{PS}={0, 1, . . . , 7} are as follows

$$\begin{matrix}[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , \\ [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .\end{matrix}$$

When d_{PS}=2, the 4 possible realizations of E corresponding to m_{PS}={0, 1, 2, 3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0, 1, 2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0, 1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

NR Rel. 15 Type-I codebook is the baseline codebook for NR, with a variety of configurations. One utility of Rel. 15 Type-I codebook is a special case of NR Rel. 15 Type-II codebook with L=1 for RI=1, 2, where a phase coupling value is reported for each sub-band, e.g., W_{2,l} is 2×N₃, with the first row equal to [1, 1, . . . , 1] and the second row equal to [e^{j2πØ}^{₀}, . . . , e^{j2πØN}^{₃₋₁}]. Under specific configurations, φ₀=φ₁ . . . =φ, e.g., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining. More details on NR Rel. 15 Type-I codebook can be found in R1-1709232, Samsung et al., “WF on Type I and II CSI codebooks,” Hangzhou, China, May 15-19, 2017, hereinafter referenced as [2].

For NR Rel. 16 Type-II Codebook, the gNB is equipped with a 2D antenna array with N₁N₂ antenna ports per polarization (Ny being the horizontal and N₂ the vertical dimension of the array). In the frequency domain, communication occurs over N₃ PMI sub-bands, where a sub-band includes a set of RBs, each RB including a set of subcarriers. Considering dual-polarization, there are 2N₁N₂ CSI-RS ports are utilized to enable DL channel estimation with high resolution for NR Rel. 16 Type-II codebook. In order to reduce feedback overhead in UL, a DFT-based transformation is used to project the channel onto L spatial beams (shared by both polarizations) where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] ,$$

$${ν}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T} ,$$

$$B = [ \begin{matrix}{ν}_{{l}_{0} , {m}_{0}} & {ν}_{{l}_{1} , {m}_{1}} & ⋯ & {ν}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. It is to be noted that O₁, O₂ oversampling factors are assumed for the 2D DFT matrix from which matrix B is drawn. Additionally, W₁ is common across all layers. W_{f,l} is an N₃×M matrix (M<N₃) with columns selected from a critically-sampled size-N₃ DFT matrix, as follows:

$${w}_{f , l} = [ \begin{matrix}{f}_{{k}_{0}} & {f}_{{k}_{1}} & ⋯ & {f}_{{k}_{{M}^{′} - 1}}\end{matrix} ] , 0 \leq {k}_{i} \leq {N}_{3} - 1 ,$$

$${f}_{k} = {[ \begin{matrix}1 & {e}^{- j \frac{2 π k}{{N}_{3}}} & ⋯ & {e}^{- j \frac{2 π k ( {N}_{3} - 1 )}{{N}_{3}}}\end{matrix} ]}^{T} .$$

The indices of the L selected columns of B may be reported, along with the oversampling index taking on O₁O₂ values. Similarly, for W_{f,l}, the indices of the M selected columns out of the predefined size-N₃ DFT matrix are reported. In the sequel the indices of the M dimensions are referred as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, and W_{f,l} are selected independently for different layers. Amplitude and phase values of an approximately β fraction of the 2 LM available coefficients are reported to the gNB (β<1) as part of the CSI report. It is to be noted that coefficients with zero amplitude values are indicated via a layer-specific bitmap matrix Sₗ of size 2L×M, where each bit of the bitmap matrix Sₗ indicates whether a coefficient has a zero-amplitude value, where for these coefficients no quantized amplitude and phase values may be reported. Since all non-zero coefficients reported within a layer are normalized with respect to the coefficient with the largest amplitude value (strongest coefficient), where the amplitude and phase values corresponding to the strongest coefficient are set to one and zero, respectively, and hence no further amplitude and phase information is explicitly reported for this coefficient, and an indication of the index of the strongest coefficient per layer is reported. Hence, for a single-layer transmission, amplitude, and phase values of a maximum of [2βLM]−1 coefficients (along with the indices of selected L, M DFT vectors) are reported per layer, leading to significant reduction in CSI report size, compared with reporting 2N₁N₂×N₃−1 coefficients' information.

For NR Rel. 16 Type-II Port Selection Codebook, K (where K≤2N₁N₂) beamformed CSI-RS ports are utilized in DL transmission, in order to reduce complexity. The K×N₃ codebook matrix per layer takes on the form as discussed in [1].

$${W}_{l} = {W}_{1}^{PS} {\tilde{W}}_{2 , l} {W}_{f , l}^{H} .$$

Here, W_{2,l} and W_{f,l} follow the same structure as the conventional NR Rel. 16 Type-II Codebook, where both are layer specific. The matrix

$${W}_{1}^{PS}$$

is a K×2L block-diagonal matrix with the same structure as that in the NR Rel. 15 Type-II Port Selection Codebook.

The NR Rel. 17 Type-II Port Selection Codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, where this selection is common across all layers. Here, \tilde{W}_{2,l} and \tilde{W}_{f,l} follow the same structure as the conventional NR Rel. 16 Type-II Codebook, however M is limited to {1, 2}, with the network configuring a window of size NE {2, 4} for M=2. Moreover, the bitmap is reported unless β=1 and the UE reports all the coefficients for a rank up to a value of two.

For Rel-18 potential Type-II codebook, the time-domain corresponding to slots is further compressed via DFT-based transformation, where the codebook is in the following form

$${W}_{l} = {W}_{1} {{\overline{W}}_{2 , l} ( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically-sampled size-N₄ DFT matrix, as follows

$${W}_{d , l} = [ \begin{matrix}{d}_{{q}_{0}} & {d}_{{q}_{1}} & ⋯ & {d}_{{q}_{Q - 1}}\end{matrix} ] , 0 \leq {q}_{i} \leq {N}_{4} - 1 ,$$

$${d}_{q} = {[ \begin{matrix}1 & {e}^{- j \frac{2 π q}{{N}_{4}}} & ⋯ & {e}^{- j \frac{2 π q ( {N}_{4} - 1 )}{{N}_{4}}}\end{matrix} ]}^{T} .$$

The indices of the Q selected columns of W_{d,l} are reported. It is to be noted that that W_{d,l} may be layer specific, e.g., W_{d,1}≠W_{d,2}, or layer common, i.e., W_{d,1}= . . . =W_{d,RI}, where RI corresponds to the total number of layers, and the operator ⊗ corresponds to a Kronecker matrix product. Here, \tilde{W}_{2,l} is a 2L×MQ sized matrix with layer-specific entries representing the LCCs corresponding to the spatial-domain, frequency-domain and time-domain DFT-basis vectors. Thereby, a size 2L×MQ bitmap may be reported associated with Rel-18 Type-II codebook.

For CSI reporting the codebook report is partitioned into two parts based on the priority of information reported. Each part is encoded separately (Part 1 has a possibly higher code rate). Below we list the parameters for NR Rel. 16 Type-II codebook. More details can be found in clause 5.2.3-4 of [1].

For content of a CSI report:
Part 1: RI+channel quality indicator (CQI)+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning can be performed to allow dynamic reporting size for codebook based on available resources in the UL phase. More details can be found in clause 5.2.3 of [1].

Also, Type-II codebook is based on aperiodic CSI reporting, and reported in physical uplink shared channel (PUSCH) via downlink control information (DCI) triggering (one exception). Type-I codebook can be based on periodic CSI reporting (e.g., physical uplink control channel (PUCCH)) or semi-persistent CSI reporting (PUSCH or PUCCH) or aperiodic reporting (PUSCH).

For triggering aperiodic CSI reporting on PUSCH, a UE is to report CSI information for the network using the CSI framework in NR Release 15. The triggering mechanism between a report setting and a resource setting can be summarized in Table 1 below.

TABLE 1

| | | | Semi-Persistent | Access Point |
|---|---|---|---|---|
| | | Periodic CSI | (SP) CSI | (AP) CSI |
| | | reporting | reporting | Reporting |
| Time Domain | Periodic CSI-RS | RRC configured | medium access | DCI |
| Behavior of | | | control (MAC) | |
| Resource Setting | | | control element | |
| | | | (CE) (PUCCH) | |
| | | | DCI (PUSCH) | |
| | SP CSI-RS | Not Supported | MAC CE (PUCCH) | DCI |
| | | | DCI (PUSCH) | |
| | AP CSI-RS | Not Supported | Not Supported | DCI |

Further, associated Resource Settings for a CSI Report Setting may have a same time domain behavior. Periodic CSI-RS/interference management (IM) resource and CSI reports can be assumed to be present and active once configured by RRC. Aperiodic and semi-persistent CSI-RS/IM resources and CSI reports can be explicitly triggered or activated. For aperiodic CSI-RS/IM resources and aperiodic CSI reports, triggering can be done jointly by transmitting a DCI Format 0-1. Semi-persistent CSI-RS/IM resources and semi-persistent CSI reports can be independently activated.

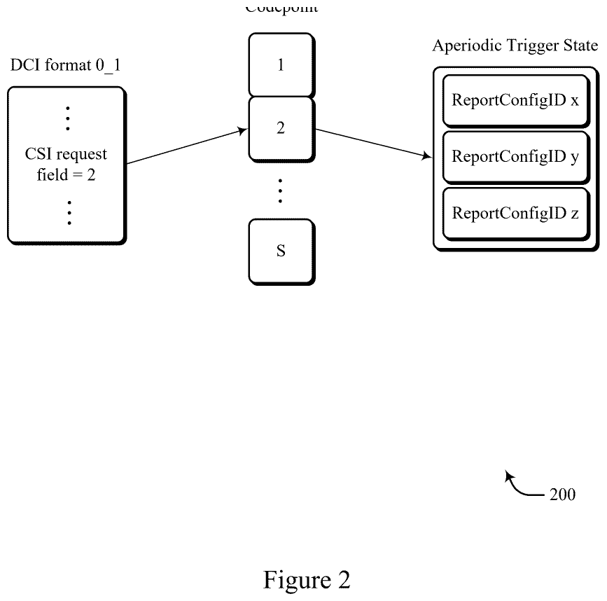

FIG. 2 illustrates a scenario 200 for aperiodic trigger state defining a list of CSI report settings. For aperiodic CSI-RS/IM resources and aperiodic CSI reports, the triggering can be performed jointly by transmitting a DCI Format 0_1. The DCI Format 0_1 can include a CSI request field, e.g., 0 to 6 bits. A non-zero CSI request field can point to the aperiodic trigger state configured by RRC. An aperiodic trigger state can be defined as a list of up to 16 aperiodic CSI report settings, identified by a CSI report setting ID (“ReportConfigID”) for which the UE calculates CSI and transmits the CSI on a scheduled PUSCH transmission.

When the CSI report setting is linked with aperiodic resource setting (e.g., including multiple resource sets), the aperiodic NZP CSI-RS resource set for channel measurement, the aperiodic CSI-IM resource set, and the aperiodic NZP CSI-RS resource set for IM to use for a given CSI report setting can also be included in the aperiodic trigger state definition. For aperiodic NZP CSI-RS, the quasi co-location (QCL) source to use can also be configured in the aperiodic trigger state. A UE can determine that the resources used for the computation of the channel and interference can be processed with the same spatial filter e.g. QCL'd with respect to QCL-TypeD.

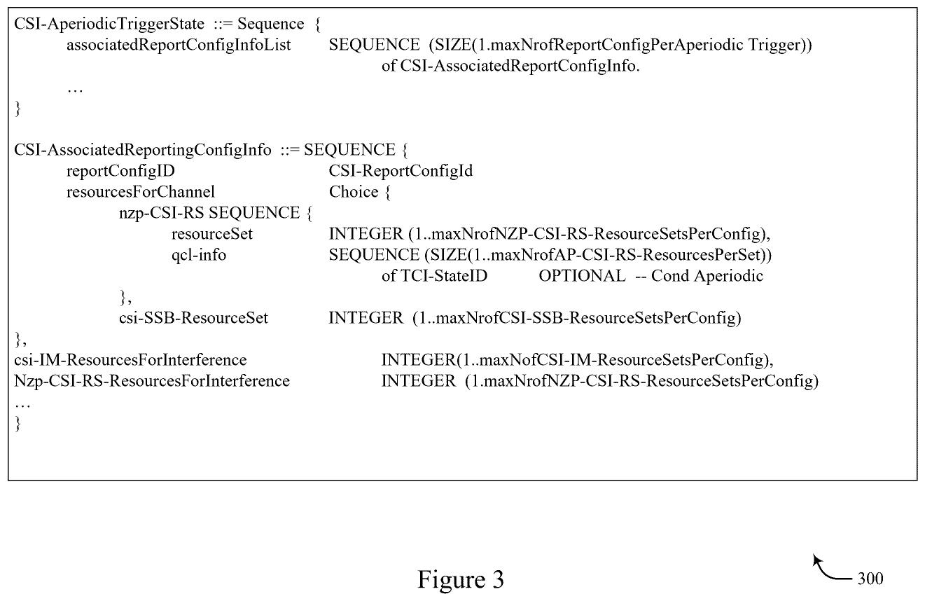

FIG. 3 illustrates aperiodic trigger state 300 indicating a resource set and QCL information. The aperiodic trigger state 300, for example, can be utilized for configuring CSI reported by UE. With reference to the present disclosure, the aperiodic trigger state 300 can be used by a UE to generate and transmit CSI reports based on the described CSI framework.

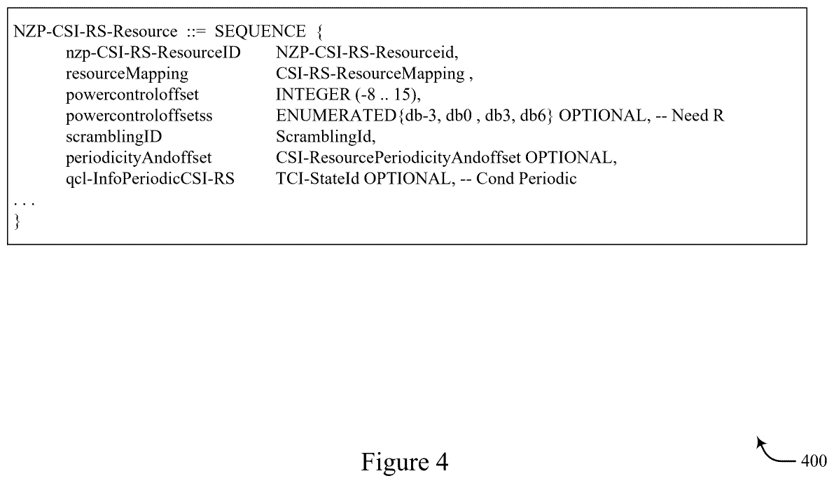

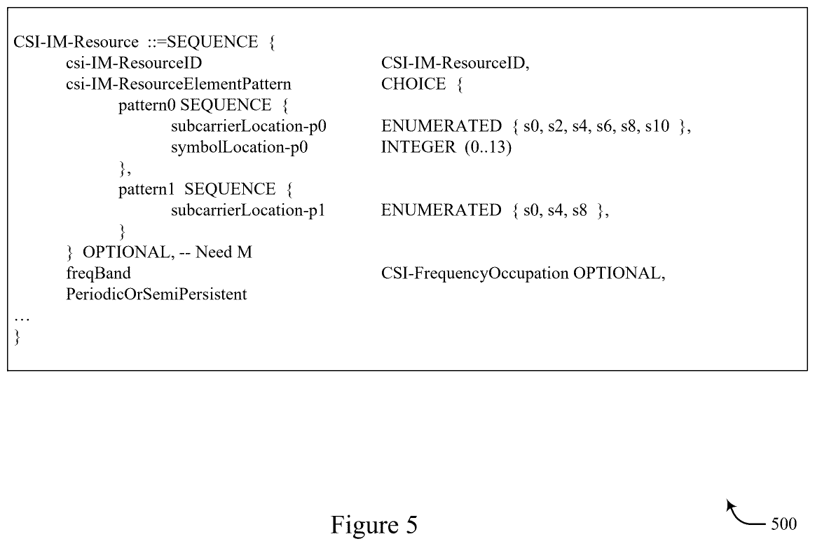

FIG. 4 illustrates RRC configuration 400 for NZP-CSI-RS and FIG. 5 illustrates RRC configuration 500 for CSI-IM resources. In implementations, the RRC configuration 400 can be used by a UE to identify NZP-CSI-RS resources, such as NZP-CSI-RS resources that correspond to beams that the UE receives and measures for determining whether near field events occur, as described throughout this disclosure. The RRC configuration 500 can be used to identify interference management resources, such as for identifying and managing signal interference between an NE and a UE.

For aperiodic CSI reporting, PUSCH-based reports can be divided into two CSI parts: CSI Part1 and CSI Part 2. The size of CSI payloads can vary significantly, and therefore an uplink control information (UCI) payload size design may result in large overhead. CSI Part 1 has a fixed payload size (and can be decoded by the gNB without prior information) and includes the following: RI (if reported), CSI-RS Resource Index (CRI)) (if reported) and CQI for the first codeword; number of non-zero wideband amplitude coefficients per layer for Type II CSI feedback on PUSCH.

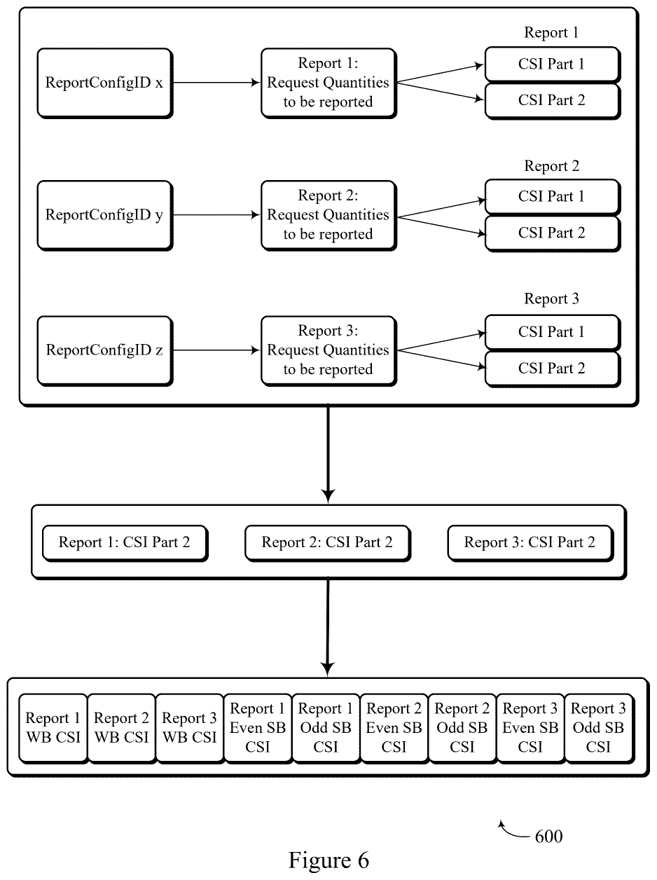

FIG. 6 illustrates a scenario 600 for partial CSI omission. The scenario 600, for example, illustrates a packing order of CSI parts within the CSI report to be transmitted within the UCI. The CSI measured from one or more reference signals is mapped to one or more CSI reports, where the packing of the CSI is as illustrated. In the scenario 600, CSI Part 2 has a variable payload size that can be derived from the CSI parameters in CSI Part 1, and can include PMI and the CQI for the second codeword when RI>4. For example, if the aperiodic trigger state indicated by DCI format 0_1 defines 3 report settings (“ReportConfigIDs”) x, y, and z, the aperiodic CSI reporting for CSI part 2 can be ordered as indicated in the scenario 600. The scenario 600 includes reports for wide-band (“WB”) and sub-band (“SB”).

CSI reports can be prioritized according to (1) time-domain behavior and physical channel, where more dynamic reports are given precedence over less dynamic reports and PUSCH has precedence over PUCCH; (2) CSI content, where beam reports (e.g., L1-RSRP reporting) may have priority over regular CSI reports; (3) the serving cell to which the CSI corresponds (in case of carrier aggregation (CA) operation)-CSI corresponding to the PCell may have priority over CSI corresponding to Scells; (4) the reportConfigID.

Codebook Subset Restriction (CBSR) has been supported for NR Rel. 15 Type-I and Type-II CSI for controlling inter-cell interference levels. In Type-I CBSR, a size N₁N₂O₁O₂ bitmap is used to indicate the restricted beam, where N₁/N₂ and O₁/O₂ indicate the number of horizontal/vertical ports and horizontal/vertical oversampling factors, respectively. Each bit in the sequence is used to restrict a certain DFT beam for a given oversampling index.

The bitmap parameter typeI-SinglePanel-codebookSubsetRestriction-i2 forms the bit sequence b₁₅, . . . , b₁, b₀ where b₀ is the least significant bit (LSB) and b₁₅ is the most significant bit (MSB). The bit bᵢ is associated with precoders corresponding to codebook index i₂=i. When bᵢ is zero, the randomly selected precoder for CQI calculation is not allowed to correspond to any precoder associated with the bit bᵢ.

In Type-II CBSR, instead of a hard restriction decision, i.e., a DFT beam within an oversampling index is either fully prohibited or unrestrictedly available, an amplitude restriction is further imposed as follows: (1) The N₁N₂O₁O₂ candidate DFT beams are re-grouped into O₁O₂ beam groups (beams within a beam group may not belong to the same oversampling index); (2) Beam restriction is allowed on 4 out of the O₁O₂ beam groups, i.e.,

$$⌈ {log}_{2} {C}_{4}^{{O}_{1} {O}_{2}} ⌉$$

bits are used to indicate the restricted beam groups; (3) For the 4N₁N₂ restricted beams across the 4 beam groups, 2 bits are allocated per beam to indicate the restriction on the maximum allowed amplitude value from a codebook of amplitude value restrictions, where the amplitude restriction,

$$Amp . = \{ 1 , {( \frac{1}{2} )}^{\frac{1}{2}} , {( \frac{1}{4} )}^{\frac{1}{2}} , 0 \} ,$$

i.e., −3 dB step size per restriction value in power domain. Hence, 8N₁N₂ bits can be used to report the amplitude restrictions for the 4 restricted beam groups based on Type-II soft restriction.

The bitmap parameter n1-n2-codebookSubsetRestriction-r16 forms the bit sequence B=B₁B₂ and configures the vector group indices g^{(k)} as in clause 5.2.2.2.3. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude γ_{i+pL} (p=0, 1), with i∈{0, 1, . . . , L−1} corresponding to a beam index, of the coefficients associated with the vector in group g^{(k)} indexed by x₁, x₂, where the maximum amplitudes are given in Table 2 and the average coefficient amplitude is restricted as follows

$$\sqrt{\frac{1}{{\sum }_{f = 0}^{{M}_{υ - 1}} {k}_{l , i + pL , f}^{( 3 )}} {\sum }_{f = 0}^{{M}_{υ} - 1} {{k}_{l , i + pL , f}^{( 3 )} ( {p}_{l , p}^{( 1 )} {p}_{l , i + pL , f}^{( 2 )} )}^{2}} \leq {γ}_{i + p L}$$

for l=1, . . . , v, is a layer index, f∈{0, 1, . . . , Mᵥ−1} is a frequency-domain basis index, and p=0, 1 is a polarization index. A UE that does not report the parameter softAmpRestriction-r16=‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01 or 10.$$

TABLE 2

| | Maximum |
|---|---|
| | Average |
| Bit | Coefficient |
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Amplitude γ_{i+pL} |
| 00 | 0 |
| 01 | \sqrt{1/4} |
| 10 | \sqrt{1/2} |
| 11 | 1 |

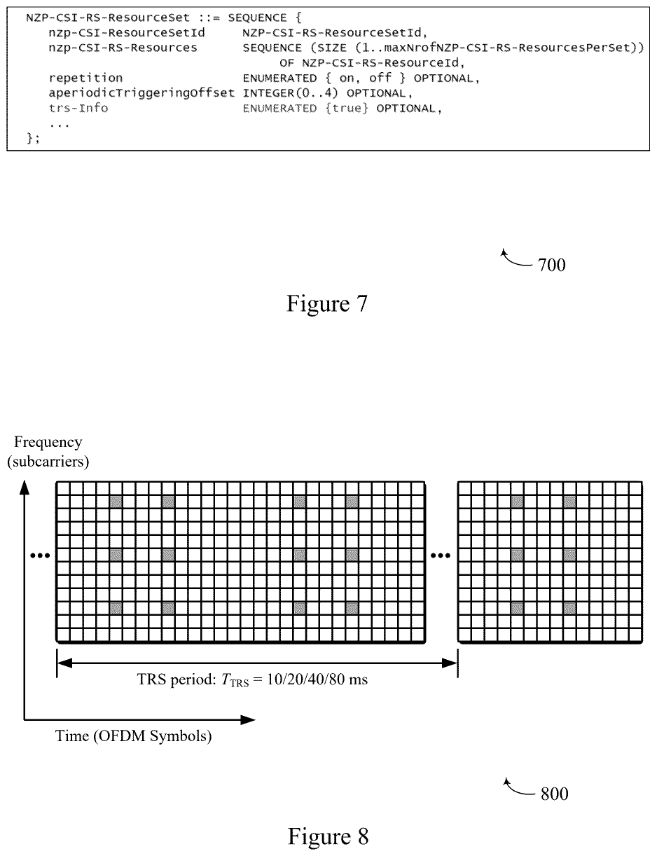

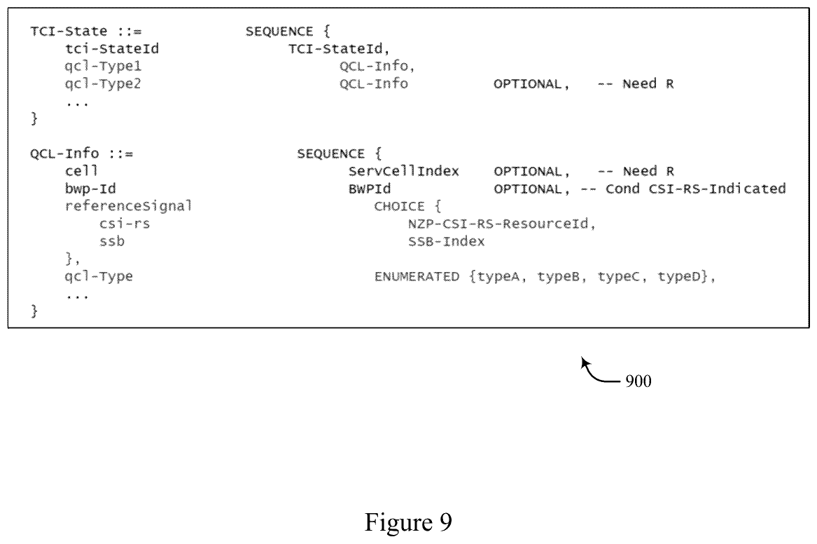

FIG. 7 illustrates example information element 700 for configuring an NZP-CSI-RS resource set. The information element 700, for instance, represents abstract syntax notation (ASN)-1 code that pertains to multi-resolution precoding based on multiple submatrices in accordance with aspects of the present disclosure. Tracking reference signal (TRS) can be transmitted for establishing fine time and frequency synchronization at a UE to aid in demodulation of physical downlink shared channel (PDSCH), particularly for higher order modulations. A TRS is an NZP CSI-RS resource set with “TRS-info” set to true. As shown in the information element 700, “trs-info” indicates that the antenna port for all NZP-CSI-RS resources in the CSI-RS resource set is the same. The TRS includes either 2 or 4 periodic CSI-RS resources with periodicity 2^{-μ}*Xp slots where Xp=10, 20, 40, or 80 and where u is related to the sub carrier spacing (SCS), e.g. μ=0, 1, 2, 3, 4 for 15, 30, 60, 120, 240 kHz, respectively. The slot offsets for the 2 or 4 CSI-RS resources are configured such that the first pair of resources are transmitted in one slot, and the 2nd pair (if configured) are transmitted in the next (adjacent) slot. All four resources are single port with density 3, as further shown in FIG. 8.

FIG. 8 illustrates an example TRS configuration 800, as related to multi-resolution precoding based on multiple submatrices in accordance with aspects of the present disclosure. A TRS represents a type of CSI-RS, which in some scenarios can be used for channel measurements. For instance, the UE may be configured with multiple TRSs, where each TRS is associated with a subarray of multiple subarrays of an antenna array at the network equipment. In the TRS configuration 800, the two CSI-RS within a slot are separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability. For example, the maximum number of TRS resource sets (per component carrier (CC)) that a UE is able to track simultaneously: Candidate value set {1 to 8}. The maximum number of TRS resource sets configured to UE per CC: Candidate value set: {1 to 64}. The UE may report at least 8 for FR1 and 16 for FR2. The maximum number of TRS resource sets configured to UE across CCs: Candidate value set: {1 to 256}. The UE may report at least 16 for FR1 and 32 for FR2. Furthermore, an aperiodic TRS is a set of aperiodic CSI-RS for tracking that is optionally configured, but a periodic TRS may be configured, and its time and frequency domain configurations (except for the periodicity) may match those of the periodic TRS. The UE may assume that the aperiodic TRS resources are QCL'd with the periodic TRS resources.

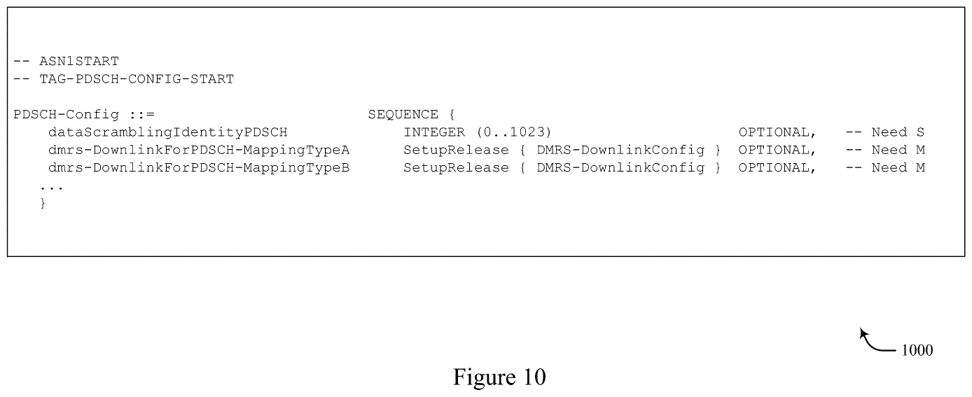

FIG. 9 illustrates an example information element 900. The information element 900, for instance, includes ASN-1 code for QCL information, as related to multi-resolution precoding based on multiple submatrices in accordance with aspects of the present disclosure. In the information element 900, a transmission configuration indicator (TCI) state (e.g., as configured by RRC) may have two QCL types (e.g., two reference signals) with the second QCL type for operation in FR2.

With reference to demodulation reference signal (DMRS) and reception of DMRS for PDSCH, QCL TypeA properties (Doppler shift, Doppler spread, average delay, delay spread) can be inferred from a periodic TRS. In turn for periodic TRS, QCL TypeC properties (Average delay, Doppler shift) can be inferred from a synchronization signal block (SSB). The DMRS is used to estimate channel coefficients for coherent detection of the physical channels. For downlink, the DMRS is subject to the same precoding as the PDSCH. NR first defines two time-domain structures for DMRS according to the location of the first DMRS symbol. For example, mapping Type A, where the first DMRS is located in the second and the third symbol of the slot, and the DMRS is mapped relative to the start of the slot boundary, regardless of where in the slot the actual data transmission occurs. Further, mapping Type B, where the first DMRS is positioned in the first symbol of the data allocation, that is, the DMRS location is not given relative to the slot boundary, rather relative to where the data are located.

The mapping of PDSCH transmission can be dynamically signaled as part of the DCI. Moreover, the DMRS has two types, Types 1 and 2, which are distinguished in frequency-domain mapping and the maximum number of orthogonal reference signals. Type 1 can provide up to four orthogonal signals using a single-symbol DMRS and up to eight orthogonal reference signals using a double-symbol DMRS. For four orthogonal signals, ports 1000 and 1001 use even-numbered subcarriers and are separated in the code domain within the code-division multiplexing (CDM) group (length-2 orthogonal sequences in the frequency domain). Antenna ports 1000 and 1001 belong to CDM group 0, since they use the same subcarriers. Similarly, ports 1002 and 1003 belong to CDM group 1 and are generated in the same way using odd-numbered subcarriers. The DMRS Type 2 has a similar structure to Type 1, but Type 2 can provide 6 and 12 patterns depending on the number of symbols. Four subcarriers are used in each resource block and in each CDM group defining three CDM groups.

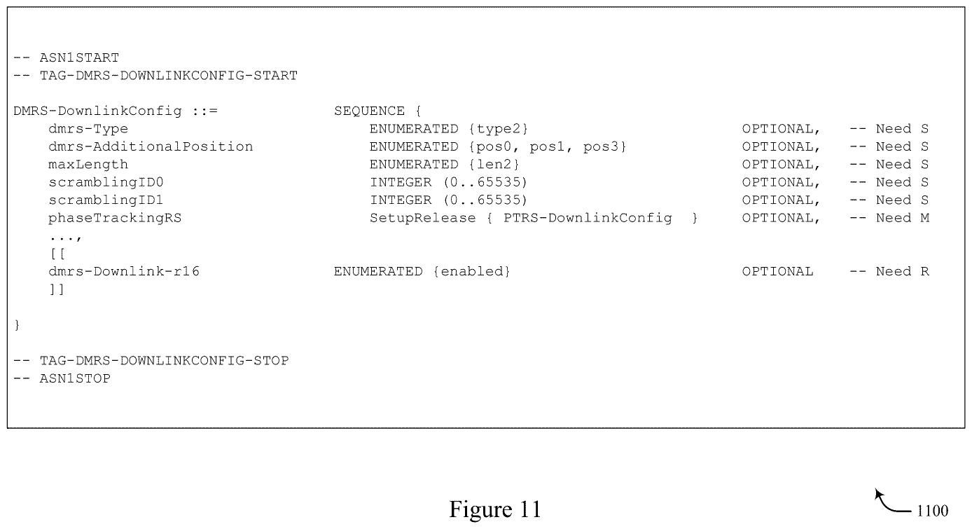

FIG. 10 illustrates an example information element 1000. The information element 1000, for instance, includes ASN-1 code for a PDSCH-Config information element. In the information element 1000, the configuration of the DMRS Type is provided through higher-layer signaling independently for each PDSCH and PUSCH, each mapping Type (A or B), and each bandwidth part (BWP) independently (see the RRC configuration). The PDSCH-Config information element (e.g., as shown in the information element 1000) can be used to configure the UE specific PDSCH parameters.

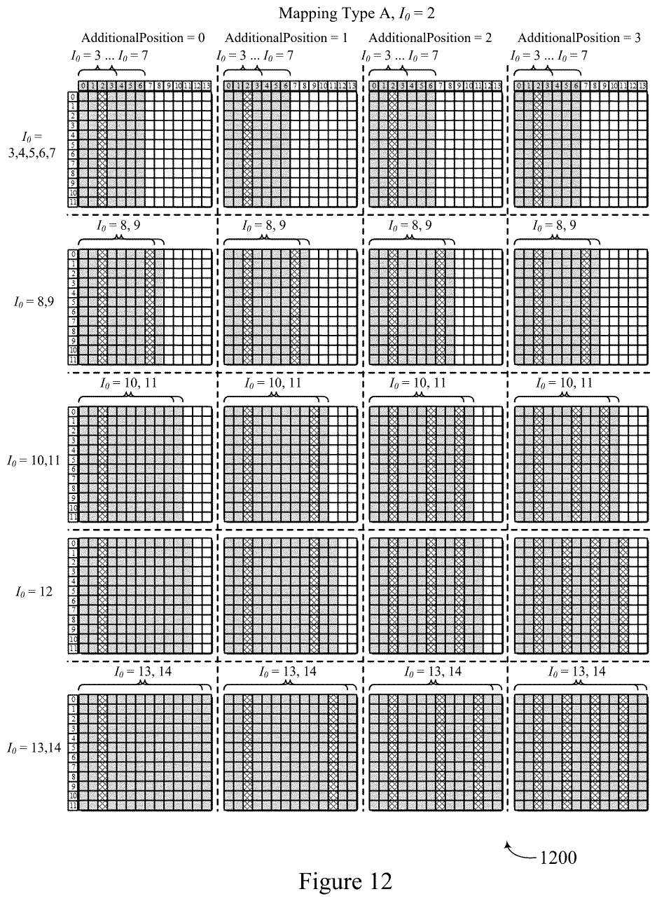

FIG. 11 illustrates an example information element 1100. The information element 1000, for instance, includes ASN-1 code for DMRS-DownlinkConfig. In the information element 1100, the information element DMRS-DownlinkConfig can be used to configure downlink demodulation reference signals for PDSCH.

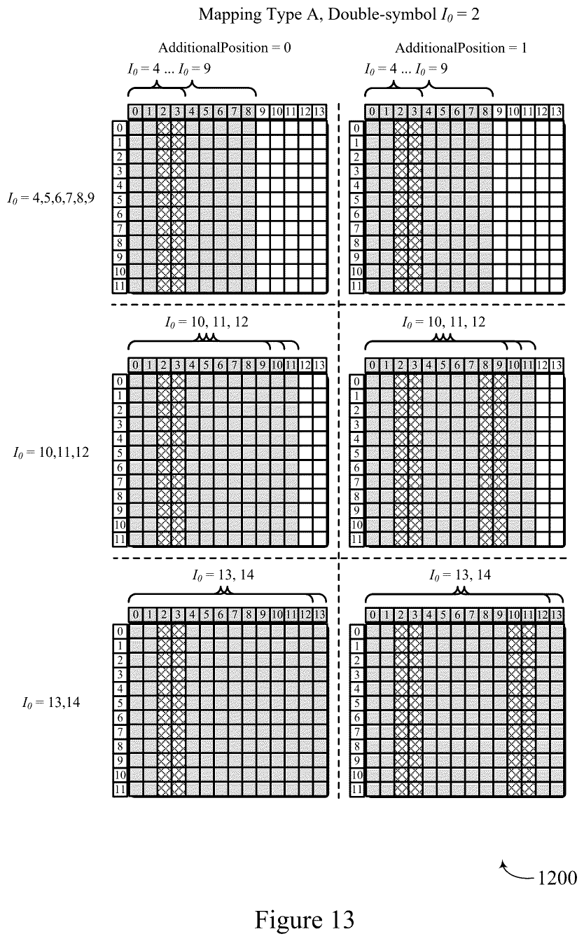

FIGS. 12 and 13 illustrate an example 1200 of DMRS patterns for mapping Type A with front-load DMRS, as related to multi-resolution precoding based on multiple submatrices in accordance with aspects of the present disclosure. The DMRS, for example, is associated with a DL data signal (e.g., DMRS for PDSCH), UL data signal (e.g., DMRS for PUSCH), or DL control signal, e.g., DMRS for physical downlink control channel (PDCCH). A DMRS for PDSCH may be mutually QCLed with multiple RSs associated with the multiple antenna subarrays of an antenna array at the network equipment.

In the example 1200, the time domain mapping of the DMRS patterns can be decomposed to two parts. For example, the first part defines the DMRS pattern used for the front-load DMRS, and then the second part defines a set of additional DMRS symbols inside the scheduled data channel duration which are either single-symbols, or double-symbols, depending on the length of the front-load DMRS. Inside the scheduled time-domain allocation of a PDSCH, the UE may expect up to 4 DMRS symbols. The location of the DMRS is defined by both higher-layer configuration and dynamic (DCI-based) signaling, such as dmrs-TypeA-Position, maxLength, and dmrs-AdditionalPosition. When double-symbol DMRS is used, there can be up to one more double-symbol DMRS (total 4 DMRS symbols inside the PDSCH allocation). Different DMRS patterns for mapping Type A with front-load DMRS are shown in the example 1200.

In the absence of CSI-RS configuration, and unless otherwise configured, the UE may assume PDSCH DMRS and synchronization signal (SS)/physical broadcast channel (PBCH) block antenna ports are QCL′d with respect to Doppler shift, Doppler spread, average delay, delay spread, and spatial Rx parameters (if applicable). However, a CSI-RS for tracking can be used as a QCL reference (e.g., having larger bandwidth than an SS/PBCH block). Furthermore, the UE may assume that the PDSCH DMRS within the same CDM group are QCL'd with respect to Doppler shift, Doppler spread, average delay, delay spread, and spatial Rx. The UE may then perform a joint estimation of DMRS ports which are CDMed using the same long-term statistics, the UE may not measure, or use, different long-term statistics for different DMRS ports of the same PDSCH.

The following discusses antenna panel/port, QCL, TCI state, and spatial relation. In some implementations, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some implementations, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, etc., may or may not be transparent to other devices. In some implementations, capability information may be communicated via signaling or, in some implementations, capability information may be provided to devices without signaling. In the case that such information is available to other devices, it can be used for signaling or local decision making.

In some implementations, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel involves biasing or powering on of the RF chain which results in current drain or power consumption in the device associated with the antenna panel (including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or include a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports are said to be QCL′d if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be QCL′d with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, QCL-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

QCL-TypeA, QCL-TypeB and QCL-TypeC may be applicable for all carrier frequencies, but the QCL-TypeD may be applicable in higher carrier frequencies (e.g., mmWave, FR2 and beyond), where the UE may not be able to perform omni-directional transmission, e.g. the UE may form beams for directional transmission. A QCL-TypeD between two reference signals A and B, the reference signal A is considered to be spatially co-located with reference signal B and the UE may assume that the reference signals A and B can be received with the same spatial filter (e.g., with the same receiver beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI state associated with a target transmission can indicate parameters for configuring a QCL relationship between the target transmission (e.g., target RS of DMRS ports of the target transmission during a transmission occasion) and a source reference signal(s) (e.g., SSB/CSI-RS/sounding reference signal (SRS)) with respect to QCL type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with QCL-Type set to ‘typeD’ in the joint TCI state.

Implementations for codebook configuration for CSI are described herein. In the discussion herein, the following notions can be used interchangeably: network nodes, transmit-receive point (TRP), panel, set of antennas, set of antenna ports, uniform linear array, cell, node, radio head, communication (e.g., signals/channels) associated with a control resource set (CORESET) pool, and communication associated with a TCI state from a transmission configuration including at least two TCI states. A TRS can represent an NZP CSI-RS resource set with a parameter ‘trs-info’ being configured. A CSI-RS for beam management can represent an NZP CSI-RS resource set with a parameter ‘repetition’ being configured. A CSI-RS for CSI corresponds to an NZP CSI-RS resource set with neither parameters ‘trs-info’ nor ‘repetition’ being configured. A matrix can represent a sequence of fields of an arbitrary dimension, including an array (vector) of values, a standard 2D matrix, and/or a Q-dimensional matrix (tensor) where Q≥2 is an integer value. A mapping between a transport block and a codeword transmitted in DL can be based on a one-to-one mapping between the TBs and codewords. The notions of “CSI reporting setting”, “CSI report setting”, “CSI reporting configuration” and “CSI report configuration” can be used interchangeably. The notions “usage case” and “usage value” are hereafter used interchangeably. Multiple implementations are described herein and one or more elements or features from one or more of the described implementations may be combined.

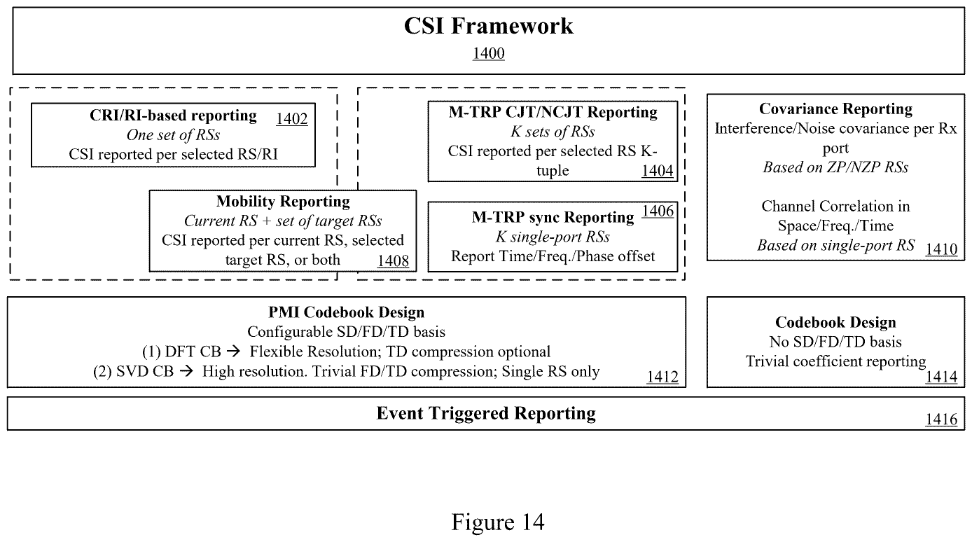

FIG. 14 illustrates an example schematic for a CSI framework 1400 in accordance with aspects of the present disclosure. The CSI framework 1400 includes different modules that pertain to CSI report configuration, RS transmission, and CSI reporting for different usage values, e.g., for different scenarios and use cases. The modules, for example, include a module 1402 which supports CRI/RI-based reporting and involves one set of RSs, where CSI can be reported per selected RS/RI. The modules further include a module 1404 which supports multiple TRP (M-TRP) coherent joint transmission (CJT) and non-CJT (NCJT) reporting involving K sets of RSs, where CSI can be reported per selected RS K-tuple. The modules further include a module 1406 which supports M-TRP synchronization reporting that can involve K single-port RSs, where one or more of time offset, frequency offset, or phase offset can be reported.

The modules further include a module 1408 which supports mobility reporting involving current RS and a set of target RSs, where CSI can be reported per current RS, selected target RS, or both. The modules further include a module 1410 which supports covariance reporting involving interference and/or noise covariance per Rx port, which can be based on zero power (ZP) and NZP RSs. The module 1410 also supports channel correlation over different domains, such as spatial domain, frequency domain, time domain, etc., which can be based on single-port RS. The modules further include a module 1412 which supports PMI codebook design involving one or more of configurable SD basis, FD basis, time domain (TD) basis, etc. The module 1412, for instance, supports DFT codebooks that enable flexible resolution where TD compression can be optional. Further, the module 1412 can support SVD codebooks that enable high resolution, which may involve trivial FD/TD compression with single RS.

The modules further include a module 1414 which supports codebook design without SD, FD, TD basis and with trivial coefficient reporting. The modules further include a module 1416 for event-triggered CSI reporting. The CSI framework 1400 thus provides a comprehensive approach to different CSI scenarios. Different features and attributes of the CSI framework 1400 and its constituent modules are described throughout this disclosure.

In implementations, usage values include a first usage value associated with CRI selection. For instance, the first usage value can correspond to a selection of an entity from a set of entities, where an entity can correspond to a node, a beam, and/or a RS. The first usage value, for example, can be associated with one of “CRI”, “selection”, or “default”. The first usage value can correspond to a selection of a subset of CSI-RS resource set(s) from a set of CSI-RS resource set(s), a selection of a subset of CSI-RS resource(s) from a set of CSI-RS resource(s), a selection of a subset of CSI-RS ports from a set of CSI-RS ports, a selection of a subset of (TRP) node(s) from a set of (TRP) node(s), a selection of a subset of beam(s) from a set of beam(s), or combinations thereof.

In implementations, the set of entities can be a superset of CSI-RS resource sets, a set of CSI-RS resources, a set of network nodes, or a set of beams. For example, a UE may not select an entity and CSI can be reported for all entity sets and/or a set includes one entity. In some examples, a subset of entities includes the set of entities, and in some other examples, the set of entities includes one entity, e.g., the selection is trivial. In an example, the UE can be configured with K CSI-RS resources, and based on CSI measurement over one or more reference signals corresponding to K CSI-RS resources, the UE can report a selected subset of K′ CSI-RS resources, where K′≤K, e.g., K′ RI values, K′ PMI values, K′ layer index (LI) values, K′ CRI values, K′ synchronization signal/physical broadcast channel (SS/PBCH) block resource index (SSBRI) values, K′ RSRP values, or K′ signal-to-interference-and-noise ratio (SINR) values.

In implementations, selection of the subset of entities from the set of entities may be performed by the UE and reported to an NE. In one example, the selection is reported in a first part of two parts of a CSI report, and a second part of the two parts includes CSI corresponding to the selected entities. In another example, the UE reports an indicator of the selected subset of entities in the set of entities, including one or more CRI values, one or more port group indicator values, CSI-RS resource set ID values, or a combination thereof. The selection of the subset of entities from the set of entities may be signaled by the NE. In one example, the selection of the subset of entities can be signaled via a signaling message, e.g., a CSI trigger message that follows a prior signaling carrying a configuration message (e.g., CSI report configuration message) that includes information of the set of entities. In another example, an indication of the subset of entities can be signaled via a DCI signal received by the UE over PDCCH, a MAC-CE signal, or an RRC configuration parameter.

In implementations, the first usage value can correspond to the selection of the subset of entities from the set of entities that is a default usage value. For instance, in absence of a configured usage value, the first usage value corresponding to the selection of the subset of entities from the set of entities can be determined by default. A UE may be configured to measure CSI corresponding to multiple CSI-RS partitions, e.g., two CSI-RS resources, two CSI-RS resource sets, or two groups of CSI-RS ports associated with different CDM groups. The UE can report CSI corresponding to the subset of entities, where CSI corresponding to each entity in the subset of entities corresponds to a different group of parameters, e.g., a different PMI value, a different group of SD basis indices, a different RI value, a different CQI value, or combinations thereof. The CSI report setting may include a report quantity value including a combination of one or more quantities (e.g., RI, PMI, CQI, LI, RSRP, SINR) where values of the one or more quantities can be reported separately for each entity of the subset of entities. In cases where CSI-RS resources include multiple ports, PMI reporting can be implemented. In cases where CSI-RS resources include a single port, beam management (BM) reporting and/or mobility reporting can be implemented. Multiple entities may correspond to multiple CSI-RS resources, each occupied with a single CSI-RS port. A UE may be configured with BM reporting for the multiple entities, where the UE can report indices of a subset of CSI-RS resources, along with corresponding measures of RSRP, SINR, channel gain, or a combination thereof.

In implementations, a second usage value can be implemented that includes CSI for reporting multiple RI values. The second usage value, for example, can correspond to measuring CSI for a different number of layers from a set of valid RI values configured in a CSI report setting. In one example, the second usage value is associated with one of “scheduling”, “rank”, or “flexible.” In an example, the second usage value is associated with reporting CSI corresponding to more than one RI value, e.g., CSI corresponding to more than one set of layers, where any two set of layers can have a different number of layers. The second usage value may be supported for the UE reporting two RI values, a first RI value corresponding to a first DL transmission of one codeword, and a second RI value corresponding to a second DL transmission of more than one codeword. More than one RI value may be reported in a form of a maximum rank value RIₘₐₓ reported in a first part of two parts of a CSI report, where CSI corresponding to at least one rank value less than RIₘₐₓ is reported. In an example, CSI corresponding to rank values of RIₘₐₓ, RIₘₐₓ-1, . . . , 2, 1 can be reported. In another example, PMI corresponding to rank values RIₘₐₓ and v can be reported, e.g., v=2.

In implementations, a UE can be configured to report CSI corresponding to multiple RI values, a first RI value corresponding to RIₘₐₓ (e.g., the largest RI value), and subsequent RI values in the multiple RI values corresponding to RI value smaller than RIₘₐₓ. For instance, a first PMI for an RI value less than RIₘₐₓ is a subset of a second PMI for RIₘₐₓ. A first PMI value can correspond to the first RI value including PMI for the RIₘₐₓ layers, and a second PMI value can correspond to a second RI value RI₂, where RI₂<RIₘₐₓ can correspond to a subset of RI₂ layers of the first PMI, out of the set of RIₘₐₓ layers of PMI. In an example, the second CSI includes an indication of a selection of RI₂ entries out of RIₘₐₓ entries (e.g., a bitmap with RIₘₐₓ entries), where RI₂ entries out of the RIₘₐₓ entries are of value 1, to identify the RI₂ layers of the first PMI that are associated with the second PMI. In another example, a first PMI associated with an RI value less than RIₘₐₓ can be a subset of a second PMI associated with an RI value equivalent to RIₘₐₓ.

CSI for each of the multiple RI values can be associated with a different CQI value (e.g., multiple CQI values can be reported), where one CQI value (e.g., the CQI value associated with RIₘₐₓ layers) can be a reference CQI value, CQI_{ref}, and a remainder of CQI values, CQIₖ (e.g., CQI values associated with a number of layers that is less than RIₘₐₓ) can be reported in a form of differential values

$$( e . g . , {CQI}_{k}^{diff} )$$

of the reference CQI value, e.g.,

$${CQI}_{k}^{d i f f} = {CQI}_{k} - {CQI}_{r e f}$$

In such scenarios, the UE can report one PMI and K layer indicators for K RI values, where each layer indicator can indicate one or more layers for a given rank value. In one example, K=RIₘₐₓ−1.

In some implementations, CSI reporting for multiple RI values over a same group of entities or CSI-RS resources can be associated with the first usage value corresponding to the selection of the subset of entities from the set of entities, where the CSI reporting of multiple RI values can be configured via a trigger within the configuration of the first usage value corresponding to the selection of the subset of entities from the set of entities. In one example, a parameter corresponding to PMI sharing for multiple RI values can configure the UE to report CSI corresponding to multiple RI values over a same group of CSI-RS resources. In one example, a number of the selected subset of entities is one, e.g., K′=1.

In implementations, a third usage value corresponding to CSI measurement and reporting under joint transmission from multiple nodes can be configured in the CSI report setting. In one example, the third usage value is associated with one of “multi-TRP”, “jointTx”, or “COMP”. A UE may be configured to compute CSI, report CSI, or both, corresponding to multiple entities, where each entity of the multiple entities is associated with a different PMI partition over multiple PMI partitions, and where an RI value (e.g., for CJT, single-frequency network (SFN)) can be common for the multiple entities. A CQI value may also be common for the multiple entities, with a possibility of a presence of two CQI values corresponding to two transport blocks or two codewords transmitted in DL signaling. A configuration parameter corresponding to coherent joint transmission, coordinated multi-point transmission, or single-frequency network transmission, may be configured or activated to identify the third usage value. Configuration involving the third usage value may be indicated via a higher-layer parameter corresponding to one of shared RI and/or coherent communication being configured.

In implementations, a UE may be configured to compute CSI, report CSI, or both, corresponding to multiple entities, where each entity of the multiple entities can be associated with a different PMI partition over multiple PMI partitions. Further, an RI value (e.g., NCJT) can be different for the multiple entities (e.g., multiple RI values can be reported), where each RI value can be associated with a PMI partition. The multiple RI values may be reported in a form of a joint parameter indicating a sequence of RI values corresponding to each entity of the multiple entities. A CQI value may also be common for the multiple entities, with a possibility of a presence of two CQI values corresponding to two transport blocks or two codewords transmitted in DL signaling, where a first subset of the multiple entities can be associated with a first of the two CQI values, and a second subset of the multiple entities can be associated with a second of the two CQI values. A configuration parameter corresponding to coherent joint transmission, coordinated multi-point transmission, or single-frequency network transmission, may be configured or activated to identify implementation of the third usage value. The third usage value may be indicated via a higher-layer parameter corresponding to one of shared RI or coherent communication not being configured or coherence transmission being configured. Multiple PMI partitions may correspond to multiple PMI values, multiple sets of PMI coefficients of a same PMI value where the multiple sets are disjoint, or a combination thereof.

In implementations, a UE can be configured to compute CSI, report CSI, or both (e.g., layered CJT, NCJT) corresponding to multiple entities and the multiple entities can be decomposed to two groups of entities. A first group of entities of the two groups of entities can be associated with a first RI value, and a second group of entities of the two groups of entities can be associated with a second RI value. The two groups of entities may be associated with a common CQI value and/or each group of entities may be associated with a different CQI value, e.g., two CQI values corresponding to two different codewords or TBs associated with the two groups of entities. In an example, the first group of entities can include two entities and the second group of entities can include two other entities, where the first group of entities can jointly transmit a first layer pair (e.g., layer 1 and layer 2), and the second group of entities can jointly transmit a second layer pair, e.g., layer 3 and layer 4. In another example, the first group of entities can include two entities and the second group of entities can include one other entity, where the first group of entities can jointly transmit a first layer pair (e.g., layer 1 and layer 2), and the other entity in the second group of entities can transmits a third layer, e.g., layer 3.

In implementations, the multiple entities may correspond to multiple CSI-RS resource sets (e.g., for BM using joint transmission), with each CSI-RS resource set including one or more CSI-RS resources occupied with a single CSI-RS port. A UE may be configured with BM reporting for the multiple entities, where the UE can report indices of single CSI-RS resources (e.g., CRI values), or can report a joint group of CSI-RS resources. In implementations, at most one CSI-RS resource from each entity, corresponding to joint communication from multiple network nodes, may be reported, along with corresponding measures of RSRP, SINR, channel gain, or a combination thereof. Alternatively, or in addition, the multiple entities may correspond to multiple SS/PBCH blocks, where a UE may be configured with BM reporting for the multiple entities. The UE may report indices of SSB (e.g., SSBRI values), and/or the UE may report a joint group of SSBRI values, with at most one SS/PBCH block from each entity corresponding to joint communication from multiple network nodes, along with corresponding measures of RSRP, SINR, channel gain, or a combination thereof.

In implementations, a fourth usage value corresponding to mobility can be configured in a CSI report setting. The fourth usage value, for example, corresponds to measurement and reporting of channel conditions based at least on a first link between a UE and a target cell, and a second link between the UE and a serving cell. In one example, the fourth usage value is associated with one of “mobility”, “Cell-Selection”, or “Handover”. The target cell may be selected from a set of one or more candidate cells. In some examples, a first list of one or more target cells and a second list of one or more candidate cells can be the same. Channel conditions may correspond to a channel quality of the first link meeting (e.g., exceeding) a first threshold, a channel quality of the second link falling below a second threshold, or a function of a ratio of the channel quality of the first link and the channel quality of the second link meeting a third threshold, or combinations thereof. The channel quality may correspond to a measure of RSRP, SINR, CQI, channel gain, or combinations thereof.

In implementations, the UE can report a delta value corresponding to a gap between the channel quality of the first link compared with the channel quality of the second link. For instance, the fourth usage value can be event triggered, such as based on channel variation including signal-to-interference ratio (SIR) calculations. Based on the reported channel quality/qualities, the UE may report CSI including at least one of RI, PMI, or CQI corresponding to the target cell based on a rule. The rule may be fixed or network configured. In an example, the rule can be based on a first RSRP value of the link associated with the target cell exceeding a second RSRP value of the link associated with the serving cell. The UE may measure SIR based on channel gain or RSRP measured via channel measurement resource (CMR) corresponding to the serving cell, and channel gain or RSRP measured via CMR corresponding to the target cell, e.g., SIR=RSRP_{service}/RSRP_{target}. In one example, the CMR corresponding to the target cell can be in a form of interference measurement resource (IMR) with one or more ports, e.g., the IMR is equipped with a single port.

Alternatively, or in addition, the UE can measure one or more SIR values based on channel gains or RSRP values measured via one or more CMR values corresponding to one or more target cells, and channel gain or RSRP measured via CMR corresponding to the serving cell, e.g., SIR=RSRP_{target}/RSRP_{service}. In one example, the one or more CMR values corresponding to the one or more target cells can be mapped to one or more ports of an IMR, e.g., each port of IMR is associated with a different CDM group. In examples discussed herein, the RS(s) corresponding to the target cell(s) can be QCLed with the RS corresponding to the serving cell at least with respect to QCL Type-D. In some implementations (e.g., for RS configuration for mobility), a configuration of DL RSs corresponding to the target cells includes multiple RSs corresponding to multiple target cells, and the multiple RSs can be configured with a same periodicity value and different offset values for periodic or semi-persistent RSs corresponding to target cells.

In implementations, a UE may be configured with measuring and reporting CSI corresponding to multiple CSI-RS resources, where the UE can compute CSI corresponding to one or more communication modes, e.g., communication hypothesis. Examples of communication modes include a first communication mode including a first CSI-RS resource of the multiple CSI-RS resources associated with the serving cell, a second communication mode including one or more CSI-RS resources of the multiple CSI-RS resources associated with one or more target cells, and a third communication mode including the two CSI-RS resources associated with joint communication with the serving cell and the target cell. The CSI-RS resources can be grouped into two groups, a first group including a single CSI-RS resource associated with a serving cell, and a second group including one or more CSI-RS resources associated with one or more target cells.

In implementations, alternating CSI-RSs can be utilized for different target cells. For instance, a UE may be configured with a CSI-RS resource and the CSI-RS resource can be associated with periodic time-domain behavior, where different transmission occasions of the CSI-RS resource correspond to different target cells, e.g., in an alternating pattern. In one example, the CSI-RS resource is associated with periodic time-domain behavior and is further associated with four target cells. For instance: (1) A first transmission occasion of a CSI-RS received over the CSI-RS resource is associated with a first target cell; (2) a second transmission occasion of the CSI-RS received over the CSI-RS resource is associated with a second target cell; (3) a third transmission occasion of the CSI-RS received over the CSI-RS resource is associated with a third target cell; (4) a fourth transmission occasion of the CSI-RS received over the CSI-RS resource is associated with a fourth target cell; (5) a fifth transmission occasion of a CSI-RS received over the CSI-RS resource is associated with a first target cell; (6) a sixth transmission occasion of the CSI-RS received over the CSI-RS resource is associated with a second target cell; (7) a seventh transmission occasion of the CSI-RS received over the CSI-RS resource is associated with a third target cell; (8) an eighth transmission occasion of the CSI-RS received over the CSI-RS resource is associated with a fourth target cell; and so on.

In implementations, an association of the CSI-RS resource with a one target cell can follow a periodicity value that is a first integer multiple of a periodicity value of the CSI-RS resource, and an offset value of the association of the CSI-RS resource with the one target cell can follow a periodicity value that is a second integer multiple of a periodicity value of the CSI-RS resource. The second integer multiple value can be smaller than the first integer multiple value. The periodicity value of the association of the CSI-RS resource with two target cells can be the same.

For mobility use cases, each CSI-RS resource may be equipped with multiple ports, via which a corresponding CSI report configuration can correspond to a reporting quantity that includes at least one of RI, PMI, or CQI. Each CSI-RS resource may be equipped with a single port, via which a corresponding CSI report configuration can correspond to a reporting quantity that includes at least one of CRI, L1-RSRP and L1-SINR. Alternatively, or in addition, each CSI-RS resource may be replaced with an SS/PBCH or an SSB, via which a corresponding CSI report configuration can correspond to a reporting quantity that includes at least one of SSBRI, L1-RSRP and L1-SINR.

In some examples, a CSI report configuration associated with the fourth usage value can be associated with a first cell, where the CSI report configuration may include a CSI resource configuration that identifies one or more CSI-RS resources, and where a subset of the one or more CSI-RS resources can be associated with a second cell. In some other examples, the fourth usage value can include a synchronization signaling over one or more of time domain, frequency domain, delay domain, Doppler domain, spatial domain and/or phase domain for one or more channels corresponding to at least one of a first link, relative to a second link, which can be reported in a CSI report associated with the fourth usage value. In cases of multiple target cells, multiple synchronization signaling values over a same domain can be reported in the CSI report associated with the fourth usage value.

In implementations, a fifth usage value can be implemented that corresponds to channel correlation and/or channel synchronization. The fifth usage value, for instance, can correspond to channel correlation measurement and/or synchronization signaling over one or more of time domain, frequency domain, delay domain, Doppler domain, spatial domain, or phase domain for one or more channels corresponding to one or more links between a UE and one or more NE. In one example, the fifth usage value is associated with one of “synchronization”, “correlation”, or “large scale parameters (LSP)”.

Alternatively, or in addition, the channel correlation measurement, synchronization signaling over time domain, frequency domain, delay domain, Doppler domain, or phase domain for one or more channels corresponding to one or more links between a UE and one or more NE may correspond to a configuration parameter in one or more usage values. For instance, for the first usage value corresponding to a selection of a subset of entities from a set of entities (e.g., usage set to “CRI”), the second usage value corresponding to CSI measurement for a different number of layers from a set of valid RI values (e.g., usage set to “multi-RI”), or the fourth usage value corresponding to mobility, the configuration parameter can indicate a measurement and reporting of channel correlation over time domain, frequency domain, delay domain, Doppler domain, spatial domain, or combinations thereof.

As another example, for the third usage value corresponding to CSI measurement and reporting under joint transmission from multiple nodes (e.g., NE) (e.g., usage set to “Joint-Transmission”), the configuration parameter can indicate a measurement and reporting of at least one of (1) time synchronization, frequency synchronization, Doppler synchronization, delay synchronization, or phase synchronization measurement across the multiple nodes, or (2) channel correlation over time domain, frequency domain, delay domain, Doppler domain, spatial domain, or combinations thereof, for a channel associated with the UE and at least one node from the multiple nodes.

As another example, for the fourth usage value corresponding to measurement and reporting of channel conditions based at least on a first link between the UE and a target cell, and a second link between the UE and a serving cell (e.g., usage set to “mobility”), the configuration parameter can indicate a measurement and reporting of at least one of time synchronization, frequency synchronization, Doppler synchronization, delay synchronization, or phase synchronization measurement across the multiple nodes, associated with the serving cell and at least one serving cell. In some examples, the configuration parameter can indicate a delay offset in units of a cyclic prefix (CP) corresponding to the target cell, with respect to a reference delay value corresponding to the serving cell.

Implementations also provide for time, frequency, and phase synchronization and time frequency, and spatial correlation. In examples, a measurement of the phase synchronization corresponds to a measurement of an offset of a phase value of a first received signal from a first node compared with a phase value of a second received signal from a second node. In examples, a measurement of the delay/time synchronization corresponds to a measurement of an offset of a delay value of a first received signal from a first node compared with a delay value of a second received signal from a second node. In examples, a measurement of the frequency/Doppler synchronization corresponds to a measurement of an offset of a frequency value of a first received signal from a first node compared with a frequency offset value of a second received signal from a second node. In examples, a measurement of the time domain correlation, Doppler domain correlation, or a time domain channel property, corresponds to a measure of a channel autocorrelation over time. In examples, a measurement of the frequency domain correlation, delay domain correlation, or a power-delay profile of a channel, corresponds to a measure of a channel autocorrelation over time. In examples, a measurement of the spatial domain correlation and spatial covariance of a multiple-input multiple-output (MIMO) channel corresponds to a measure of a channel correlation over multiple antennas.

In implementations, measurements for synchronization and correlation may be based on TRS or single-port CSI-RS resources. In examples, the measurements can be further based on SRS transmitted from the UE, where the TRS or single-port CSI-RS is based on the SRS, e.g., based on a QCL configuration, TCI configuration, or spatial correlation information exchanged between the UE and the NE in either direction. In one example, spatial correlation information is signaled from the NE to the UE via TCI configuration.

Implementations also provide for measurement of interference and noise covariance. In examples, a correlation measurement corresponds to a measurement of at least one of interference, noise, or a combination thereof, e.g., interference-plus-noise. The at least one of the interference, noise, or the combination thereof, may correspond to a NZP RS (e.g., an NZP CSI-RS resource with one or more ports) or a ZP RS (e.g., a ZP CSI-RS resource), where a number of ports corresponding to the measurement can be based on a number of ports at the UE side, UE selected, or preconfigured. In some other examples, the covariance corresponds to an autocorrelation matrix of a channel over a large period of time, or a large bandwidth, or both. A size of the autocorrelation matrix can be based on a number of ports of a corresponding RS for measurement, and an absence of configured NZP RS can indicate that the number of ports is either UE selected or set by a pre-configured rule. The correlation measurement corresponding to the measurement of the at least one of the interference, the noise, or the combination thereof, may correspond to a standalone usage value, e.g., a sixth usage value corresponding to interference covariance or correlation.

Implementations also provide for codebook enhancements, e.g., for PMI codebook types. In examples, the UE can be configured with reporting a PMI value based on a codebook type from a set of codebook types. The codebook may correspond to at least one of the first usage value, second usage value, third usage value, fourth usage value, or a combination thereof. At least three codebook types can be supported: a first codebook type corresponding to a DFT-based codebook, a second codebook type corresponding to an eigen-based codebook, and a third codebook type corresponding to a channel covariance-based precoding matrix.

The first codebook type can correspond to a precoding matrix Wₗ, for layer l, as follows:

$${W}_{l} = {W}_{1 , l} {{W}_{2 , l} ( {W}_{f , l} ⊗ {W}_{d , l} )}^{H}$$

The matrix Wₗ is of dimension Nₜ×N_{SB}N_{D}, where Nₜ is a number of antenna ports associated with the gNB, N_{SB} is a number of frequency subbands corresponding to a BWP associated with the channel, and N_{D} is a number of time occasions. The matrix W_{1,l} is a spatial-domain transformation matrix of dimension Nt×αL, where σL≤Nₜ.

In a first example, σ=1, such that W_{1,l}=Bₗ. In a second example, σ=2, such that

$${W}_{1 , l} = [ \begin{matrix}{B}_{l} & 0 \\ 0 & {B}_{l}\end{matrix} ] ,$$

and Bₗ is of dimension

$$\frac{{N}_{t}}{2} \times L$$

The matrix Bₗ is a transformation matrix with a number of columns that is no more than a number of its rows, and where columns of Bₗ are a sub-selection of L columns of a DFT matrix of size Nₜ/σ. In other examples, the matrix Bₗ comprises columns of a one-dimensional DFT matrix or a two-dimensional DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

In implementations, N₂=1, i.e., uₘ=1. In other implementations, O₁=1, O₂=1, or both. The matrix Bₗ or W_{1,l} may be common for all layers l=1, . . . , RI, where RI is a rank value, i.e., B₁=B₂= . . . =B_{RI}, or W_{1,1}=W_{1,2}= . . . =W_{1,RI}.

The matrix W_{2,l} is a coefficient matrix of size σL×MQ, where M≤N_{SB}, Q≤N_{D}A number of non-zero coefficient in the matrix, e.g., Kₗ is less than the number of matrix entries, e.g., Kₗ≤σLMQ. In examples, the UE can be configured with reporting a fraction β<1 of the σLMQ matrix entries to be non-zero, i.e., Kₗ≤σβLMQ, e.g., β=0.5.

In implementations, the UE may report an indication of the entries of the matrix W_{2,l} in a form of a bitmap of size σLMQ, a combinatorial parameter whose number of valid entries is

$${log}_{2} ( {C}_{{K}_{l}}^{σ L M Q} ) ,$$

where

$${C}_{b}^{a}$$

is an n-choose-k function whose value is equivalent to a number of all where possible permutations of b entries in a locations, where b≤a, or in terms of a coded parameter of a sequence of σLMQ, e.g., via a Huffman coding approach. Non-zero coefficients can be quantized in a scalar manner (e.g., each non-zero coefficient is quantized separately), via an amplitude quantization coefficient and a phase quantization coefficient, where the amplitude quantization codebook may follow a logarithmic quantization scale with a maximum amplitude value of one, and the phase quantization codebook may follow a uniform quantization scale between 0 and π or −π and x. In other examples, amplitude coefficients, phase coefficients, or a combination thereof may be jointly quantized with a number of quantization coefficients that is less than double a number of non-zero coefficients. In examples, a reference amplitude value associated with each entity, RS resource, beam, basis, TRP, or a combination thereof, is associated with a common amplitude coefficient that is considered a reference value for other coefficients. In examples, the reference amplitude value is associated with a fixed value, and an indication of an index corresponding to the coefficient index, beam index, basis index, TRP index, RS resource index, entity index, or a combination thereof, is signaled between the network node and the UE.

The matrix W_{f,l} is a frequency-domain or delay-domain transformation matrix of size M×N_{SB}, where M≤N_{SB}. In a first example, columns of the matrix W_{f,j} constitute M columns of a Fourier-based, e.g., DFT, matrix of size N_{SB}. In one example, a column vector y_{f} of index f of the Fourier-based matrix is in a form:

$${y}_{f} = {[ \begin{matrix}1 & {e}^{j \frac{2 π f}{{N}_{S B}}} & … & {e}^{j \frac{2 π f ( {N}_{S B} - 1 )}{{N}_{S B}}}\end{matrix} ]}^{T} .$$

In implementations, other transformations based on one or more transformation matrices are not precluded. For instance, a trivial transformation, where M=1 (e.g., a column vector whose entries are equal), is not precluded, and can correspond to wideband resolution precoding. Alternatively, or in addition, for M=N_{SB}, the matrix W_{f,l} may be an identity matrix, corresponding to sub-band resolution precoding. In another example, the matrix W_{f,l} constitutes M columns of size N_{SB} each, where each index of the M indices maps to one or more frequency subbands. For instance, each column of the M columns constitutes a set of contiguous non-zero entries (e.g., equal to one), whereas a remainder of entries of the column are of value zero. In yet another example, a transformation based on artificial intelligence/machine learning (AI/ML), where an AI/ML-based algorithm formulates the transformation matrix.

The matrix W_{d,j} is a time-domain or Doppler-domain transformation matrix of size Q×N_{D}, where Q≤N_{D}. In a first example, columns of the matrix W_{d,j} constitute Q columns of a Fourier-based, e.g., DFT, matrix of size N_{D}. In one example, a column vector zₜ of index t of the Fourier-based matrix is in a form:

$${y}_{t} = {[ \begin{matrix}1 & {e}^{j \frac{2 π t}{{N}_{D}}} & … & {e}^{j \frac{2 π t ( {N}_{D} - 1 )}{{N}_{D}}}\end{matrix} ]}^{T} .$$

Other transformations based on one or more transformation matrices are not precluded. A trivial transformation, where Q=1 (e.g., a column vector whose entries are equal) is not precluded.

In another example, the matrix W_{d,l} constitutes Q columns of size N_{D} each, where each index of the Q indices maps to one or more time indices. For instance, each column of the Q columns constitutes a set of contiguous non-zero entries (e.g., equal to one), whereas a remainder of entries of the column are of value zero. In another example, a transformation based on AI/ML, where an AI/ML-based algorithm formulates the transformation matrix.

In implementations, the matrices W_{f,l} and W_{d,l} are aggregated to a common matrix (e.g., W_{s,l}), where s corresponds to an index that is associated with a pair of values over the time domain and the frequency domain, or a transformation of at least one of the two domains. In one example, the transformation corresponds to a Fourier-based transform, a cosine-based transform, a Hadamard transform, a Haar transform, a wavelet transform, or combinations thereof.

The second codebook type for an eigen-based codebook (e.g., SVD-based) can correspond to a free precoding approach without a transformation (e.g., eigenvalue decomposition-based precoding), where a precoding matrix comprising v layers corresponds to a matrix \tilde{W}ₗ of size Nₜ×N_{SB} is supported. In some examples, the NSB subbands are decomposed to N3 groups of subbands, where a common precoding vector per layer is used for each group of the N3 groups of subbands. In some examples, N₃=N_{SB}, e.g., a common precoding vector per layer is used for an entire bandwidth part. In some examples, a time-domain transformation is not supported along with the second codebook type. The second codebook type may be restricted to be used for a maximum number of ports, e.g., 32 ports. In another example, the second codebook type is restricted for either aperiodic CSI reporting, otherwise periodic or semi-persistent CSI reporting whose periodicity is no less than a threshold, e.g., 80 ms or 80 slots. The SVD-based codebook type may be constrained to scenarios where the UE is configured with measurement of a CSI-RS within a single CSI-RS resource group. For instance, no UE-based CRI selection or multi-RI reporting may be supported, and multi-TRP reporting (e.g., CJT/NCJT) and/or mobility reporting may not be supported when SVD-based codebook type is configured.

The third codebook type for a channel covariance-based precoding matrix corresponds to a measure of a covariance, where the covariance corresponds to at least one of interference, noise, or a combination thereof, e.g., interference-plus-noise covariance. The at least one of interference, noise, or the combination thereof may correspond to a NZP RS (e.g., an NZP CSI-RS resource with one or more ports), or a ZP RS (e.g., a ZP CSI-RS resource), where a number of ports corresponding to the measurement can be based on a number of ports at the UE, UE selected, or pre-configured. In some implementations, the covariance corresponds to an autocorrelation matrix of a channel over a large period of time, or over a large bandwidth, or both, where a size of the autocorrelation matrix can be based on a number of ports of a corresponding RS for measurement, and an absence of configured NZP RS can indicate that the number of ports is either UE selected or set by a pre-configured rule.

The third codebook type can correspond to a trivial matrix with no RI value, or the RI value can be presumed to be equal to one, e.g., the measurement corresponds to a single layer. Each reported coefficient is further decomposed to at least one of an amplitude coefficient value and a phase coefficient value. A reference coefficient whose value is fixed (e.g., to an amplitude value of one with zero phase value) may be assumed. Each coefficient may be separately encoded, or alternatively a joint coding approach can be implemented across the coefficients, e.g., via Huffman coding. Each coefficient is associated with an ID value, where an indicator value that identifies coefficients whose quantized amplitude value is zero is reported, e.g., via a bitmap corresponding to a sequence of bits whose size is equivalent to a number of the coefficients. A total number of non-zero coefficients may be reported as a separate parameter that identifies a size of a CSI report corresponding to the third codebook type. In examples, the covariance corresponds to a non-negative definite (positive semi-definite) Hermitian matrix, and hence the Hermitian matrix can be represented via the diagonal entries of the matrix, in addition to one of the lower triangular matrix coefficients and the upper triangular matrix coefficients. In examples, the third codebook type corresponding to the measure of the covariance may include at least one of a spatial domain transformation parameter, a frequency domain transformation parameter, or a time domain transformation parameter, where the third codebook type is based on a NZP CSI-RS associated with interference measurement.

Implementations also provide a fourth codebook type that is based on a different basis transformation for spatial, frequency, and time domains. The fourth codebook type, for instance, represents a codebook corresponding to a PMI value that includes one or more parameters. A first of the one or more parameters corresponds to a spatial-domain transformation, a second of the one or more parameters corresponds to a frequency-domain or delay-domain transformation, and a third of the one or more parameters corresponds to a time-domain or Doppler-domain transformation.

The precoding matrix Wₗ, for layer l, is in the following form:

$${W}_{l} = {W}_{1 , l} {{W}_{2 , l} ( {W}_{f , l} ⊗ {W}_{d , l} )}^{H}$$

The matrix Wₗ is of dimension Nₜ×N_{SB}N_{D}, where Nₜ is a number of antenna ports associated with the gNB, N_{SB} is a number of frequency subbands corresponding to a BWP associated with the channel, N_{D} is a number of time occasions, and the matrix W_{2,l} is a coefficients matrix, where a subset of the coefficients of the coefficients matrix have non-zero values. At least a total number of coefficients with non-zero values and indices of the coefficients matrix with non-zero values for each layer can be reported. In examples, amplitude values and phase values of coefficients with non-zero values can be reported.

The matrices W_{1,l}, W_{f,l} and W_{d,l} correspond to a spatial-domain transformation matrix, a frequency-domain transformation matrix, and a time-domain transformation matrix, respectively. For each of the spatial-domain transformation matrix, the frequency-domain transformation matrix, and the time-domain transformation matrix, a basis type out of a set of basis types can be selected. In some implementations, the basis type selection can be performed at the network side and signaled to the UE prior to CSI reporting. In other implementations, the basis type selection can be performed at the UE and reported to the NE as part of a CSI report.

A first example of a set of basis types for the spatial-domain transformation matrix includes one or more of Fourier-based transformation, Tomlinson Hiroshima zero-forcing transformation, a Hadamard transform, a transformation that is based on a sub-selection of spatial domain indices, a transformation that increases an SINR value of the channel, a signal-to-leakage and noise ration (SLNR) of the channel, or combinations thereof. In examples, the basis may correspond to a trivial compression, e.g., mapping every group of antenna ports to a common index of the precoding. For instance, in a case with 32 antenna ports, the transformation maps a first four of the 32 antenna ports to a common first index of the precoding, a second four of the 32 antenna ports to a common second index of the precoding, and so on, and a last four of the 32 antenna ports is mapped to a common eighth index of the precoding. For example, precoding coefficients applied to two antenna ports of the same group are the same. A number of groups of frequency subbands may be a fraction of a number of the frequency subbands.

A second example of a set of basis types for the frequency-domain transformation matrix includes one or more of Fourier-based transformation, Discrete cosine transform, Discrete wavelet transform, a function of a power delay profile of the channel, or combinations thereof. In examples, the basis may correspond to a trivial compression, e.g., mapping every group of frequency subbands to a common index of the precoding. For instance, in a case with eight frequency subbands, the transformation maps a first four of the eight frequency subbands to a common first index of the precoding, and a last four of the eight frequency subbands to a common second index of the precoding. For example, a precoding vector applied to two frequency subbands of the same group is the same. A number of groups of frequency subbands may be a fraction of a number of the frequency subbands. In some other examples, the basis may be trivial, corresponding to a one-to-one mapping of frequency subband indices with transformed domain indices. For example, the transformation is a scaled identity matrix, e.g., with a scaling value of 1. The trivial basis may correspond to a frequency-domain transformation being disabled. As used herein, the notions “frequency domain” and “delay domain” may be used interchangeably.

A third example of a set of basis types for the time-domain transformation matrix includes one or more of Fourier-based transformation, Discrete cosine transform, Discrete wavelet transform, a Bessel function-based transform, or combinations thereof. In examples, the basis may correspond to a trivial compression, e.g., mapping every group of time slots to a common index of the precoding. For instance, in a case with twenty time slots, the transformation maps a first ten of the twenty time slots to a common first index of the precoding, and a last ten of the twenty time slots to a common second index of the precoding. For example, a precoding vector applied to two time slots of the same group can be the same. A number of groups of time slots may be a fraction of a number of the time slots. In some other examples, the basis may be trivial, corresponding to a one-to-one mapping of time slot indices with transformed domain indices. For instance, the transformation is a scaled identity matrix, e.g., with a scaling value of 1. The trivial basis may correspond to a time-domain transformation being disabled. As used herein, the notions “time domain” and “Doppler domain” may be used interchangeably. In some examples, the frequency-domain transformation and the time-domain transformation can be combined to a common transformation matrix, e.g., based on a wavelet transform.

Implementations herein also support event-triggered CSI reporting. In examples, the CSI report configuration comprises a parameter that indicates UE initiated or event triggered CSI reporting. The parameter, for instance, can activate event-triggered CSI reporting. For example, UE initiated or event triggered CSI reporting may correspond to at least one of the first usage value, second usage value, third usage value, fourth usage value, fifth usage value, or a combination thereof. In implementations, the CSI report configuration comprises a configured set of one or more events that the UE is to monitor, and the UE can report an indication of an occurrence of at least one event in a configured set of one or more events to the network. In a first example, the at least one event corresponds to one of an RSRP value, SINR value, CQI value, RI value associated with an RS, or an entity falling below a first threshold. The RS or the entity may be associated with a current entity that is previously selected, configured or indicated by the network, or reported by the UE. In a second example, the event corresponds to one of an RSRP value, SINR value, CQI value, RI value associated with an RS, or an entity meeting a second threshold. The RS or the entity may be associated with a candidate entity that is different from a previously selected entity indicated by the network or reported by the UE.

In a third example, the event corresponds to a difference between values meeting a threshold. For instance, the event corresponds to a difference between of one of a first RSRP value, a first SINR value, a first CQI value, a first RI value associated with a first RS, or a first entity, and a second RSRP value, a second SINR value, a second CQI value, or a second RI value, meeting a threshold. In a fourth example, the event corresponds to a difference of one of a first RSRP value, a first SINR value, a first CQI value, a first RI value associated with a first RS, or a first entity, and a second RSRP value, a second SINR value, a second CQI value, or a second RI value falling below a threshold. In a fifth example, the event corresponds to a synchronization value in time, delay, frequency, Doppler, or phase corresponding to the third usage value increasing beyond a given threshold for the third usage value. In a sixth example, the event corresponds to a delta change of a correlation of a channel in the time domain, frequency domain or spatial domain at a first time instant exceeding a threshold compared with the correlation of the channel in the time domain, frequency domain or spatial domain at a second time instant that precedes the first time instant.

Regarding content of an event-triggered CSI report, the UE can be configured with receiving one or more RSs corresponding to the respective usage value. Further, the UE can feed back CSI over at least two parts. In examples, the two parts correspond to two parts of a same CSI report. In some examples, a first of the two parts of the CSI corresponds to a scheduling request parameter. In other examples, the first of the two parts of the CSI is a sequence of one or more UCI bits reported over either PUSCH or PUCCH.

In examples, the two parts correspond to two different CSI reports. In another example, the first of the two parts of the CSI can be implemented as a scheduling request corresponding to scheduling a CSI report over an UL resource.

A first part of the two parts of the CSI can include at least one of: A first parameter corresponding to the indication of the occurrence of the at least one event in the configured set of one or more events; a second parameter corresponding to an indication of an event index in case more than one event is configured; a third parameter corresponding to a measure of the event, e.g., a delta value by which an RSRP value monitored within the event has exceeded a threshold value, where the event can correspond to the RSRP value meeting the threshold value; a fourth parameter that characterizes a size of a second part of the two parts of the CSI, if reported. In some examples, the characterized size of the second of the two parts of the CSI can be zero, indicating that the second part of the two parts of the CSI is not reported.

A second part of the two parts of the CSI, if reported, can include at least one of: (1) CSI corresponding to one of the first usage value, the second usage value, the third usage value, the fourth usage value or the fifth usage value, where the CSI comprises parameters of a full CSI report corresponding to the corresponding usage value, e.g., a CSI report corresponding to network-configured reporting; (2) an index of a beam, entity, SSB, CSI-RS resource, or TRS, whose corresponding CQI, RI, RSRP, SINR, synchronization value in time domain, Doppler domain, frequency domain, delay domain, phase domain, a covariance of a channel in time domain, frequency domain or spatial domain is improved compared with a current beam, entity, SSB, CSI-RS resource, or TRS; (3) a value of a CQI, RI, RSRP, or SINR, synchronization value in time domain, Doppler domain, frequency domain, delay domain, phase domain, a covariance of a channel in time domain, frequency domain or spatial domain of a beam, entity, SSB, CSI-RS resource, or TRS corresponding to a new beam, entity, SSB, CSI-RS resource, or TRS compared with a currently configured or selected beam, entity, SSB, CSI-RS resource, or TRS; (4) a value of a CQI, RI, RSRP, or SINR, synchronization value in time domain, Doppler domain, frequency domain, delay domain, phase domain, a covariance of a channel in time domain, frequency domain or spatial domain of a beam, entity, SSB, CSI-RS resource, or TRS corresponding to a current beam, entity, SSB, CSI-RS resource, TRS.

In implementations, a mapping of RSs to report quantities is provided. For instance, the CSI report configuration includes a mapping of a resource to an RI index, a PMI index, a CQI index, an RSRP index, an SINR index, or combinations thereof. The mapping can be specified via multiple implementation alternatives. In a first implementation, each entity (e.g., CSI-RS resource) can be associated with at least one RI index, at least one PMI index, at least one CQI index, at least one RSRP index, at least one SINR index, or combinations thereof. In a second implementation, each report quantity (e.g., RI, PMI, CQI, RSRP, SINR) can be associated with a least one entity, e.g., CSI-RS resource.

In implementations, each entity (e.g., CSI-RS resource) can be associated with at least one report quantity (e.g., RI, PMI, CQI, RSRP, SINR) as part of the CSI report configuration. After receiving the CSI report configuration, the UE further receives a trigger message that maps an entity with at least one usage value. For instance, the UE is triggered with measuring and reporting CSI corresponding to the first usage value and the fourth usage value, where a same CSI-RS resource can be utilized in part to pursue measurements for the two usage values. The CSI report configuration can include an indication of a CSI resource configuration associated with entities (e.g., CSI-RS resources) associated with the measurement and reporting of CSI. The CSI report configuration can also include a set of report quantity values to be reported for each CSI-RS resource. The CSI report configuration can be a higher-layer signal, e.g., RRC signal.

A CSI report trigger can include a mapping of each entity (e.g., CSI-RS resource) to a usage value, where the reported CSI can be determined by both the CSI report configuration and the CSI report trigger. In examples, a container of the CSI report can be signaled to the UE within the CSI report trigger. The CSI report trigger may be a higher-layer signal (e.g., MAC-CE or RRC signal) or a physical layer signal (e.g., DCI) based on a time-domain behavior of the CSI reporting included in the CSI report configuration. If the entity corresponds to a CSI-RS resource, or other RS resource, the entity may include no less than two RS ports.

Implementations also provide for RI restriction reporting. For instance, the CSI report configuration can be associated with a PMI reporting, and the CSI report configuration may further include an RI restriction. The RI restriction can be implemented as: A parameter including one RI value, where the one RI value is a maximum RI value the UE can report under the said CSI report configuration; a joint parameter corresponding to multiple RI values, where the joint parameter indicates whether each RI value in a set of RI values is allowable to be reported by the UE.

Implementations also provide for measures of coherence bandwidth for beam squinting. For example, the CSI report configuration may trigger the UE to measure a coherence bandwidth, or report an indication of a frequency band under a squinting effect, a channel distortion, or a channel coherence bandwidth under which a signal experiences no larger than a configured distortion measure.

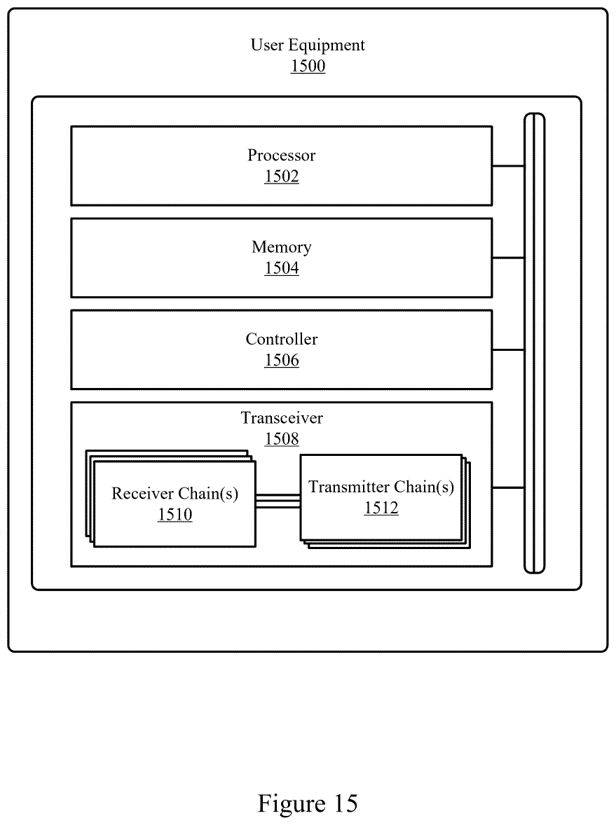

FIG. 15 illustrates an example of a UE 1500 in accordance with aspects of the present disclosure. The UE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the UE 1500 to perform various functions of the present disclosure.

The memory 1504 may include volatile or non-volatile memory. The memory 1504 may store computer-readable, computer-executable code including instructions when executed by the processor 1502 cause the UE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the UE 1500 to perform one or more of the functions described herein (e.g., executing, by the processor 1502, instructions stored in the memory 1504). For example, the processor 1502 may support wireless communication at the UE 1500 in accordance with examples as disclosed herein. The UE 1500 may be configured to or operable to support a means for receiving CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; measuring CSI based at least in part on one or more received RSs; and transmitting a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain.

Additionally, the UE 1500 may be configured to support any one or combination of where the first transformation is based on at least one of: a first subset of columns of a first DFT matrix; a zero-forcing precoder that minimizes interference at the UE of a signal from a NE intended for another UE; a Hadamard transformation; a trivial selection of a subset of antenna ports; or a transformation corresponding to distinct precoder coefficient values for individual antenna ports; the second transformation is based on at least one of: a second subset of columns of a second DFT matrix; a one-to-one transformation corresponding to a distinct precoder for each subband in the frequency domain; a many-to-one transformation corresponding to a distinct precoder coefficient for each group of multiple groups of contiguous subbands in the frequency domain; a trivial transformation corresponding to a wideband precoder coefficient that is common for all subbands in a bandwidth part; a transformation based on a power-delay profile of a channel associated with the UE and a NE; a discrete cosine transform; or a discrete wavelet transform; the third transformation is based on at least one of: a third subset of columns of a third DFT matrix; a one-to-one transformation corresponding to a distinct precoder coefficient for each slot in the time domain; a many-to-one transformation corresponding to a distinct precoder coefficient for each group of multiple groups of contiguous slots; a Bessel function-based transform; a discrete cosine transform; or a discrete wavelet transform.

Additionally, the UE 1500 may be configured to support any one or combination of where the second transformation and the third transformation are implemented jointly as a single transformation; the set of CSI parameters further include an indication of a set of precoder coefficients based on one or more of: a first transformed domain based on the first transformation; a second transformed domain based on the second transformation; a third transformed domain based on the third transformation; or an indication of a subset of precoder coefficients in the set of precoder coefficients with non-zero amplitude values; the codebook type corresponds to a Fourier-based codebook type; the first transformation is based on a first subset of columns of a first DFT matrix; and the second transformation is based on a combination of a second subset of columns of a second DFT matrix, where a distinct precoder for each group of multiple groups of contiguous subbands in the frequency domain is applied; the third transformation is based on at least one of: a third subset of columns of a third DFT matrix; a one-to-one transformation corresponding to a distinct precoder for each slot in the time domain; or a many-to-one transformation corresponding to a distinct precoder for each group of multiple groups of contiguous slots; the codebook type corresponds to a SVD-based codebook type.

Additionally, the UE 1500 may be configured to support any one or combination of where the first transformation is based on a trivial transformation corresponding to a distinct precoder coefficient for individual antenna ports based on an SVD of a corresponding channel matrix; the second transformation is based on a many-to-one transformation corresponding to a distinct precoder coefficient for each group of multiple groups of contiguous subbands in the frequency domain; and the third transformation is based on a many-to-one transformation corresponding to a distinct precoder coefficient for each group of multiple groups of contiguous slots; the one or more received RSs include NZP CSI-RSs configured for channel measurement; the codebook type corresponds to a covariance-based codebook type; the covariance-based codebook type corresponds to one or more of interference or noise measured at the UE; the one or more received RSs include one or more of: NZP CSI-RSs configured for interference measurement; or ZP CSI-RSs configured for interference measurement; the set of CSI parameters include one or more of: identification of a subset of precoder coefficients with non-zero amplitude values from a set of coefficients; or amplitude values and phase values corresponding to the subset of precoder coefficients; the covariance-based codebook type corresponds to a measure of an autocorrelation of a channel in one or more of the time domain, Doppler domain, the frequency domain, delay domain, or the spatial domain.

Additionally, or alternatively, the UE 1500 may support at least one memory (e.g., the memory 1504) and at least one processor (e.g., the processor 1502) coupled with the at least one memory and configured to cause the UE to receive CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; measure CSI based at least in part on one or more received RSs; and transmit a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain.

Additionally, the UE 1500 may be configured to support any one or combination of where the first transformation is based on at least one of: a first subset of columns of a first DFT matrix; a zero-forcing precoder that minimizes interference at the UE of a signal from a NE intended for another UE; a Hadamard transformation; a trivial selection of a subset of antenna ports; or a transformation corresponding to distinct precoder coefficient values for individual antenna ports; the second transformation is based on at least one of: a second subset of columns of a second DFT matrix; a one-to-one transformation corresponding to a distinct precoder for each subband in the frequency domain; a many-to-one transformation corresponding to a distinct precoder coefficient for each group of multiple groups of contiguous subbands in the frequency domain; a trivial transformation corresponding to a wideband precoder coefficient that is common for all subbands in a bandwidth part; a transformation based on a power-delay profile of a channel associated with the UE and a NE; a discrete cosine transform; or a discrete wavelet transform; the third transformation is based on at least one of: a third subset of columns of a third DFT matrix; a one-to-one transformation corresponding to a distinct precoder coefficient for each slot in the time domain; a many-to-one transformation corresponding to a distinct precoder coefficient for each group of multiple groups of contiguous slots; a Bessel function-based transform; a discrete cosine transform; or a discrete wavelet transform.

Additionally, the UE 1500 may be configured to support any one or combination of where the second transformation and the third transformation are implemented jointly as a single transformation; the set of CSI parameters further include an indication of a set of precoder coefficients based on one or more of: a first transformed domain based on the first transformation; a second transformed domain based on the second transformation; a third transformed domain based on the third transformation; or an indication of a subset of precoder coefficients in the set of precoder coefficients with non-zero amplitude values; the codebook type corresponds to a Fourier-based codebook type; the first transformation is based on a first subset of columns of a first DFT matrix; and the second transformation is based on a combination of a second subset of columns of a second DFT matrix, where a distinct precoder for each group of multiple groups of contiguous subbands in the frequency domain is applied; the third transformation is based on at least one of: a third subset of columns of a third DFT matrix; a one-to-one transformation corresponding to a distinct precoder for each slot in the time domain; or a many-to-one transformation corresponding to a distinct precoder for each group of multiple groups of contiguous slots; the codebook type corresponds to a SVD-based codebook type.

Additionally, the UE 1500 may be configured to support any one or combination of where the first transformation is based on a trivial transformation corresponding to a distinct precoder coefficient for individual antenna ports based on an SVD of a corresponding channel matrix; the second transformation is based on a many-to-one transformation corresponding to a distinct precoder coefficient for each group of multiple groups of contiguous subbands in the frequency domain; and the third transformation is based on a many-to-one transformation corresponding to a distinct precoder coefficient for each group of multiple groups of contiguous slots; the one or more received RSs include NZP CSI-RSs configured for channel measurement; the codebook type corresponds to a covariance-based codebook type; the covariance-based codebook type corresponds to one or more of interference or noise measured at the UE; the one or more received RSs include one or more of: NZP CSI-RSs configured for interference measurement; or ZP CSI-RSs configured for interference measurement; the set of CSI parameters include one or more of: identification of a subset of precoder coefficients with non-zero amplitude values from a set of coefficients; or amplitude values and phase values corresponding to the subset of precoder coefficients; the covariance-based codebook type corresponds to a measure of an autocorrelation of a channel in one or more of the time domain, Doppler domain, the frequency domain, delay domain, or the spatial domain.

The controller 1506 may manage input and output signals for the UE 1500. The controller 1506 may also manage peripherals not integrated into the UE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the UE 1500 may include at least one transceiver 1508. In some other implementations, the UE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

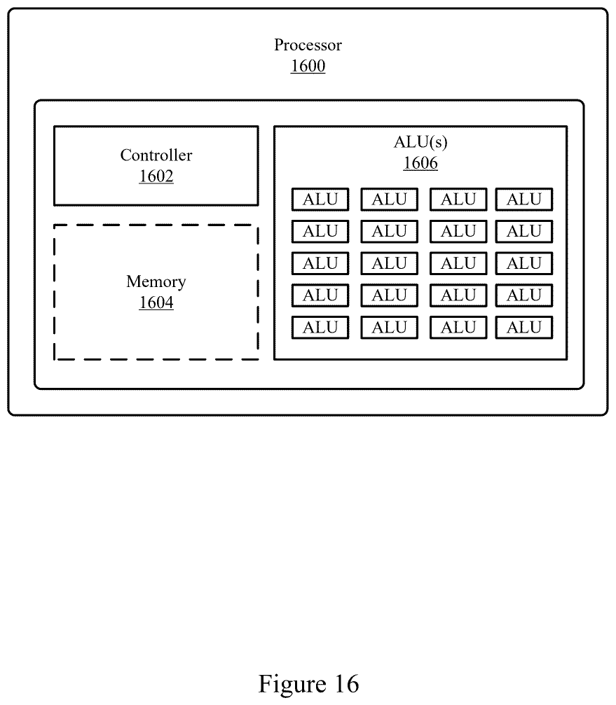

FIG. 16 illustrates an example of a processor 1600 in accordance with aspects of the present disclosure. The processor 1600 may be an example of a processor configured to perform various operations in accordance with examples as described herein. The processor 1600 may include a controller 1602 configured to perform various operations in accordance with examples as described herein. The processor 1600 may optionally include at least one memory 1604, which may be, for example, an L1/L2/L3 cache. Additionally, or alternatively, the processor 1600 may optionally include one or more arithmetic-logic units (ALUs) 1606. One or more of these components may be in electronic communication or otherwise coupled (e.g., operatively, communicatively, functionally, electronically, electrically) via one or more interfaces (e.g., buses).

The processor 1600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1602 may be configured to manage and coordinate various operations (e.g., signaling, receiving, obtaining, retrieving, transmitting, outputting, forwarding, storing, determining, identifying, accessing, writing, reading) of the processor 1600 to cause the processor 1600 to support various operations in accordance with examples as described herein. For example, the controller 1602 may operate as a control unit of the processor 1600, generating control signals that manage the operation of various components of the processor 1600. These control signals include enabling or disabling functional units, selecting data paths, initiating memory access, and coordinating timing of operations.

The controller 1602 may be configured to fetch (e.g., obtain, retrieve, receive) instructions from the memory 1604 and determine subsequent instruction(s) to be executed to cause the processor 1600 to support various operations in accordance with examples as described herein. The controller 1602 may be configured to track memory addresses of instructions associated with the memory 1604. The controller 1602 may be configured to decode instructions to determine the operation to be performed and the operands involved. For example, the controller 1602 may be configured to interpret the instruction and determine control signals to be output to other components of the processor 1600 to cause the processor 1600 to support various operations in accordance with examples as described herein. Additionally, or alternatively, the controller 1602 may be configured to manage flow of data within the processor 1600. The controller 1602 may be configured to control transfer of data between registers, ALUs 1606, and other functional units of the processor 1600.

The memory 1604 may include one or more caches (e.g., memory local to or included in the processor 1600 or other memory, such as RAM, ROM, DRAM, SDRAM, SRAM, MRAM, flash memory, etc. In some implementations, the memory 1604 may reside within or on a processor chipset (e.g., local to the processor 1600). In some other implementations, the memory 1604 may reside external to the processor chipset (e.g., remote to the processor 1600).

The memory 1604 may store computer-readable, computer-executable code including instructions that, when executed by the processor 1600, cause the processor 1600 to perform various functions described herein. The code may be stored in a non-transitory computer-readable medium such as system memory or another type of memory. The controller 1602 and/or the processor 1600 may be configured to execute computer-readable instructions stored in the memory 1604 to cause the processor 1600 to perform various functions. For example, the processor 1600 and/or the controller 1602 may be coupled with or to the memory 1604, the processor 1600, and the controller 1602, and may be configured to perform various functions described herein. In some examples, the processor 1600 may include multiple processors and the memory 1604 may include multiple memories. One or more of the multiple processors may be coupled with one or more of the multiple memories, which may, individually or collectively, be configured to perform various functions herein.

The one or more ALUs 1606 may be configured to support various operations in accordance with examples as described herein. In some implementations, the one or more ALUs 1606 may reside within or on a processor chipset (e.g., the processor 1600). In some other implementations, the one or more ALUs 1606 may reside external to the processor chipset (e.g., the processor 1600). One or more ALUs 1606 may perform one or more computations such as addition, subtraction, multiplication, and division on data. For example, one or more ALUs 1606 may receive input operands and an operation code, which determines an operation to be executed. One or more ALUs 1606 may be configured with a variety of logical and arithmetic circuits, including adders, subtractors, shifters, and logic gates, to process and manipulate the data according to the operation. Additionally, or alternatively, the one or more ALUs 1606 may support logical operations such as AND, OR, exclusive-OR (XOR), not-OR (NOR), and not-AND (NAND), enabling the one or more ALUs 1606 to handle conditional operations, comparisons, and bitwise operations.

The processor 1600 may support wireless communication in accordance with examples as disclosed herein. The processor 1600 may be configured to or operable to support at least one controller (e.g., the controller 1602) coupled with at least one memory (e.g., the memory 1604) and configured to cause the processor to receive CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; measure CSI based at least in part on one or more received RSs; and transmit a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain.

Additionally, the processor 1600 may be configured to or operable to support any one or combination of where the first transformation is based on at least one of: a first subset of columns of a first DFT matrix; a zero-forcing precoder that minimizes interference at the UE of a signal from a NE intended for another UE; a Hadamard transformation; a trivial selection of a subset of antenna ports; or a transformation corresponding to distinct precoder coefficient values for individual antenna ports; the second transformation is based on at least one of: a second subset of columns of a second DFT matrix; a one-to-one transformation corresponding to a distinct precoder for each subband in the frequency domain; a many-to-one transformation corresponding to a distinct precoder coefficient for each group of multiple groups of contiguous subbands in the frequency domain; a trivial transformation corresponding to a wideband precoder coefficient that is common for all subbands in a bandwidth part; a transformation based on a power-delay profile of a channel associated with the UE and a NE; a discrete cosine transform; or a discrete wavelet transform; the third transformation is based on at least one of: a third subset of columns of a third DFT matrix; a one-to-one transformation corresponding to a distinct precoder coefficient for each slot in the time domain; a many-to-one transformation corresponding to a distinct precoder coefficient for each group of multiple groups of contiguous slots; a Bessel function-based transform; a discrete cosine transform; or a discrete wavelet transform.

Additionally, the processor 1600 may be configured to or operable to support any one or combination of where the second transformation and the third transformation are implemented jointly as a single transformation; the set of CSI parameters further include an indication of a set of precoder coefficients based on one or more of: a first transformed domain based on the first transformation; a second transformed domain based on the second transformation; a third transformed domain based on the third transformation; or an indication of a subset of precoder coefficients in the set of precoder coefficients with non-zero amplitude values; the codebook type corresponds to a Fourier-based codebook type; the first transformation is based on a first subset of columns of a first DFT matrix; and the second transformation is based on a combination of a second subset of columns of a second DFT matrix, where a distinct precoder for each group of multiple groups of contiguous subbands in the frequency domain is applied; the third transformation is based on at least one of: a third subset of columns of a third DFT matrix; a one-to-one transformation corresponding to a distinct precoder for each slot in the time domain; or a many-to-one transformation corresponding to a distinct precoder for each group of multiple groups of contiguous slots; the codebook type corresponds to a SVD-based codebook type.

Additionally, the processor 1600 may be configured to or operable to support any one or combination of where: the first transformation is based on a trivial transformation corresponding to a distinct precoder coefficient for individual antenna ports based on an SVD of a corresponding channel matrix; the second transformation is based on a many-to-one transformation corresponding to a distinct precoder coefficient for each group of multiple groups of contiguous subbands in the frequency domain; and the third transformation is based on a many-to-one transformation corresponding to a distinct precoder coefficient for each group of multiple groups of contiguous slots; the one or more received RSs include NZP CSI-RSs configured for channel measurement; the codebook type corresponds to a covariance-based codebook type; the covariance-based codebook type corresponds to one or more of interference or noise measured at the UE; the one or more received RSs include one or more of: NZP CSI-RSs configured for interference measurement; or ZP CSI-RSs configured for interference measurement; the set of CSI parameters include one or more of: identification of a subset of precoder coefficients with non-zero amplitude values from a set of coefficients; or amplitude values and phase values corresponding to the subset of precoder coefficients; the covariance-based codebook type corresponds to a measure of an autocorrelation of a channel in one or more of the time domain, Doppler domain, the frequency domain, delay domain, or the spatial domain.

The processor 1600 may support wireless communication in accordance with examples as disclosed herein. The processor 1600 may be configured to or operable to support at least one controller (e.g., the controller 1602) coupled with at least one memory (e.g., the memory 1604) and configured to cause the processor to transmit CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; and receive a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain.

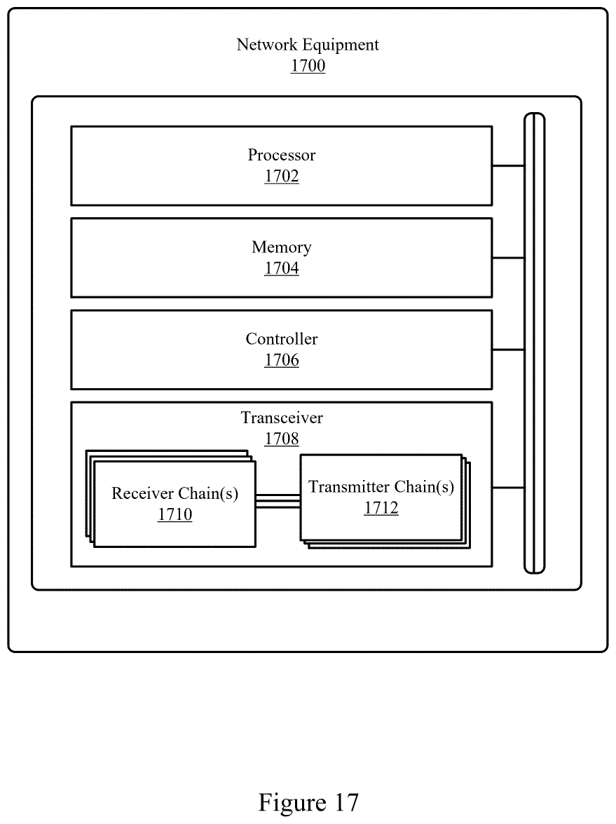

FIG. 17 illustrates an example of an NE 1700 in accordance with aspects of the present disclosure. The NE 1700 may include a processor 1702, a memory 1704, a controller 1706, and a transceiver 1708. The processor 1702, the memory 1704, the controller 1706, or the transceiver 1708, or various combinations thereof or various components thereof may be examples of means for performing various aspects of the present disclosure as described herein. These components may be coupled (e.g., operatively, communicatively, functionally, electronically, electrically) via one or more interfaces.

The processor 1702, the memory 1704, the controller 1706, or the transceiver 1708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1702 may include an intelligent hardware device (e.g., a general-purpose processor, a DSP, a CPU, an ASIC, an FPGA, or any combination thereof). In some implementations, the processor 1702 may be configured to operate the memory 1704. In some other implementations, the memory 1704 may be integrated into the processor 1702. The processor 1702 may be configured to execute computer-readable instructions stored in the memory 1704 to cause the NE 1700 to perform various functions of the present disclosure.

The memory 1704 may include volatile or non-volatile memory. The memory 1704 may store computer-readable, computer-executable code including instructions when executed by the processor 1702 cause the NE 1700 to perform various functions described herein. The code may be stored in a non-transitory computer-readable medium such as the memory 1704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1702 and the memory 1704 coupled with the processor 1702 may be configured to cause the NE 1700 to perform one or more of the functions described herein (e.g., executing, by the processor 1702, instructions stored in the memory 1704). For example, the processor 1702 may support wireless communication at the NE 1700 in accordance with examples as disclosed herein. The NE 1700 may be configured to or operable to support a means for transmitting CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; and receiving a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain.

Additionally, the NE 1700 may be configured to or operable to support any one or combination of where the first transformation is based on at least one of: a first subset of columns of a first DFT matrix; a zero-forcing precoder that minimizes interference at the UE of a signal from a NE intended for another UE; a Hadamard transformation; a trivial selection of a subset of antenna ports; or a transformation corresponding to distinct precoder coefficient values for individual antenna ports; the second transformation is based on at least one of: a second subset of columns of a second DFT matrix; a one-to-one transformation corresponding to a distinct precoder for each subband in the frequency domain; a many-to-one transformation corresponding to a distinct precoder coefficient for each group of multiple groups of contiguous subbands in the frequency domain; a trivial transformation corresponding to a wideband precoder coefficient that is common for all subbands in a bandwidth part; a transformation based on a power-delay profile of a channel associated with the UE and a NE; a discrete cosine transform; or a discrete wavelet transform; the third transformation is based on at least one of: a third subset of columns of a third DFT matrix; a one-to-one transformation corresponding to a distinct precoder coefficient for each slot in the time domain; a many-to-one transformation corresponding to a distinct precoder coefficient for each group of multiple groups of contiguous slots; a Bessel function-based transform; a discrete cosine transform; or a discrete wavelet transform.

Additionally, the NE 1700 may be configured to or operable to support any one or combination of where the second transformation and the third transformation are implemented jointly as a single transformation; the set of CSI parameters further include an indication of a set of precoder coefficients based on one or more of: a first transformed domain based on the first transformation; a second transformed domain based on the second transformation; a third transformed domain based on the third transformation; or an indication of a subset of precoder coefficients in the set of precoder coefficients with non-zero amplitude values; the codebook type corresponds to a Fourier-based codebook type; the first transformation is based on a first subset of columns of a first DFT matrix; and the second transformation is based on a combination of a second subset of columns of a second DFT matrix, where a distinct precoder for each group of multiple groups of contiguous subbands in the frequency domain is applied; the third transformation is based on at least one of: a third subset of columns of a third DFT matrix; a one-to-one transformation corresponding to a distinct precoder for each slot in the time domain; or a many-to-one transformation corresponding to a distinct precoder for each group of multiple groups of contiguous slots; the codebook type corresponds to a SVD-based codebook type.

Additionally, the NE 1700 may be configured to or operable to support any one or combination of where the first transformation is based on a trivial transformation corresponding to a distinct precoder coefficient for individual antenna ports based on an SVD of a corresponding channel matrix; the second transformation is based on a many-to-one transformation corresponding to a distinct precoder coefficient for each group of multiple groups of contiguous subbands in the frequency domain; and the third transformation is based on a many-to-one transformation corresponding to a distinct precoder coefficient for each group of multiple groups of contiguous slots; one or more transmitted RSs include NZP CSI-RSs configured for channel measurement; the codebook type corresponds to a covariance-based codebook type; the covariance-based codebook type corresponds to one or more of interference or noise measured at a UE; the one or more received RSs include one or more of: NZP CSI-RSs configured for interference measurement; or ZP CSI-RSs configured for interference measurement; the set of CSI parameters include one or more of: identification of a subset of precoder coefficients with non-zero amplitude values from a set of coefficients; or amplitude values and phase values corresponding to the subset of precoder coefficients; the covariance-based codebook type corresponds to a measure of an autocorrelation of a channel in one or more of the time domain, Doppler domain, the frequency domain, delay domain, or the spatial domain.

Additionally, or alternatively, the NE 1700 may support at least one memory (e.g., the memory 1704) and at least one processor (e.g., the processor 1702) coupled with the at least one memory and configured to cause the NE to transmit CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain; and receive a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain.

Additionally, the NE 1700 may be configured to or operable to support any one or combination of where the first transformation is based on at least one of: a first subset of columns of a first DFT matrix; a zero-forcing precoder that minimizes interference at the UE of a signal from a NE intended for another UE; a Hadamard transformation; a trivial selection of a subset of antenna ports; or a transformation corresponding to distinct precoder coefficient values for individual antenna ports; the second transformation is based on at least one of: a second subset of columns of a second DFT matrix; a one-to-one transformation corresponding to a distinct precoder for each subband in the frequency domain; a many-to-one transformation corresponding to a distinct precoder coefficient for each group of multiple groups of contiguous subbands in the frequency domain; a trivial transformation corresponding to a wideband precoder coefficient that is common for all subbands in a bandwidth part; a transformation based on a power-delay profile of a channel associated with the UE and a NE; a discrete cosine transform; or a discrete wavelet transform; the third transformation is based on at least one of: a third subset of columns of a third DFT matrix; a one-to-one transformation corresponding to a distinct precoder coefficient for each slot in the time domain; a many-to-one transformation corresponding to a distinct precoder coefficient for each group of multiple groups of contiguous slots; a Bessel function-based transform; a discrete cosine transform; or a discrete wavelet transform.

Additionally, the NE 1700 may be configured to or operable to support any one or combination of where the second transformation and the third transformation are implemented jointly as a single transformation; the set of CSI parameters further include an indication of a set of precoder coefficients based on one or more of: a first transformed domain based on the first transformation; a second transformed domain based on the second transformation; a third transformed domain based on the third transformation; or an indication of a subset of precoder coefficients in the set of precoder coefficients with non-zero amplitude values; the codebook type corresponds to a Fourier-based codebook type; the first transformation is based on a first subset of columns of a first DFT matrix; and the second transformation is based on a combination of a second subset of columns of a second DFT matrix, where a distinct precoder for each group of multiple groups of contiguous subbands in the frequency domain is applied; the third transformation is based on at least one of: a third subset of columns of a third DFT matrix; a one-to-one transformation corresponding to a distinct precoder for each slot in the time domain; or a many-to-one transformation corresponding to a distinct precoder for each group of multiple groups of contiguous slots; the codebook type corresponds to a SVD-based codebook type.

Additionally, the NE 1700 may be configured to or operable to support any one or combination of where the first transformation is based on a trivial transformation corresponding to a distinct precoder coefficient for individual antenna ports based on an SVD of a corresponding channel matrix; the second transformation is based on a many-to-one transformation corresponding to a distinct precoder coefficient for each group of multiple groups of contiguous subbands in the frequency domain; and the third transformation is based on a many-to-one transformation corresponding to a distinct precoder coefficient for each group of multiple groups of contiguous slots; one or more transmitted RSs include NZP CSI-RSs configured for channel measurement; the codebook type corresponds to a covariance-based codebook type; the covariance-based codebook type corresponds to one or more of interference or noise measured at a UE; the one or more received RSs include one or more of: NZP CSI-RSs configured for interference measurement; or ZP CSI-RSs configured for interference measurement; the set of CSI parameters include one or more of: identification of a subset of precoder coefficients with non-zero amplitude values from a set of coefficients; or amplitude values and phase values corresponding to the subset of precoder coefficients; the covariance-based codebook type corresponds to a measure of an autocorrelation of a channel in one or more of the time domain, Doppler domain, the frequency domain, delay domain, or the spatial domain.

The controller 1706 may manage input and output signals for the NE 1700. The controller 1706 may also manage peripherals not integrated into the NE 1700. In some implementations, the controller 1706 may utilize an operating system such as iOS®, ANDROID®, WINDOWS®, or other operating systems. In some implementations, the controller 1706 may be implemented as part of the processor 1702.

In some implementations, the NE 1700 may include at least one transceiver 1708. In some other implementations, the NE 1700 may have more than one transceiver 1708. The transceiver 1708 may represent a wireless transceiver. The transceiver 1708 may include one or more receiver chains 1710, one or more transmitter chains 1712, or a combination thereof.

A receiver chain 1710 may be configured to receive signals (e.g., control information, data, packets) over a wireless medium. For example, the receiver chain 1710 may include one or more antennas to receive a signal over the air or wireless medium. The receiver chain 1710 may include at least one amplifier (e.g., a low-noise amplifier (LNA)) configured to amplify the received signal. The receiver chain 1710 may include at least one demodulator configured to demodulate the receive signal and obtain the transmitted data by reversing the modulation technique applied during transmission of the signal. The receiver chain 1710 may include at least one decoder for decoding the demodulated signal to receive the transmitted data.

A transmitter chain 1712 may be configured to generate and transmit signals (e.g., control information, data, packets). The transmitter chain 1712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1712 may also include at least one power amplifier configured to amplify the modulated signal to an appropriate power level suitable for transmission over the wireless medium. The transmitter chain 1712 may also include one or more antennas for transmitting the amplified signal into the air or wireless medium.

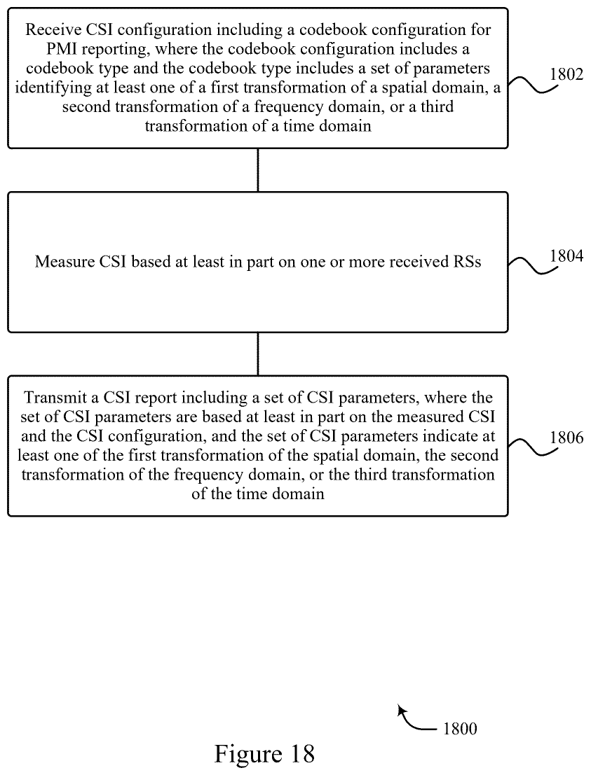

FIG. 18 illustrates a flowchart of a method 1800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1802, the method may include receiving CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain. The operations of 1802 may be performed in accordance with examples as described herein. In some implementations, aspects of the operations of 1802 may be performed by a UE as described with reference to FIG. 15.

At 1804, the method may include measuring CSI based at least in part on one or more received RSs. The operations of 1804 may be performed in accordance with examples as described herein. In some implementations, aspects of the operations of 1804 may be performed by a UE as described with reference to FIG. 15.

At 1806, the method may include transmitting a CSI report including a set of CSI parameters, where the set of CSI parameters are based at least in part on the measured CSI and the CSI configuration, and the set of CSI parameters indicate at least one of the first transformation of the spatial domain, the second transformation of the frequency domain, or the third transformation of the time domain. The operations of 1806 may be performed in accordance with examples as described herein. In some implementations, aspects of the operations of 1806 may be performed a UE as described with reference to FIG. 15.

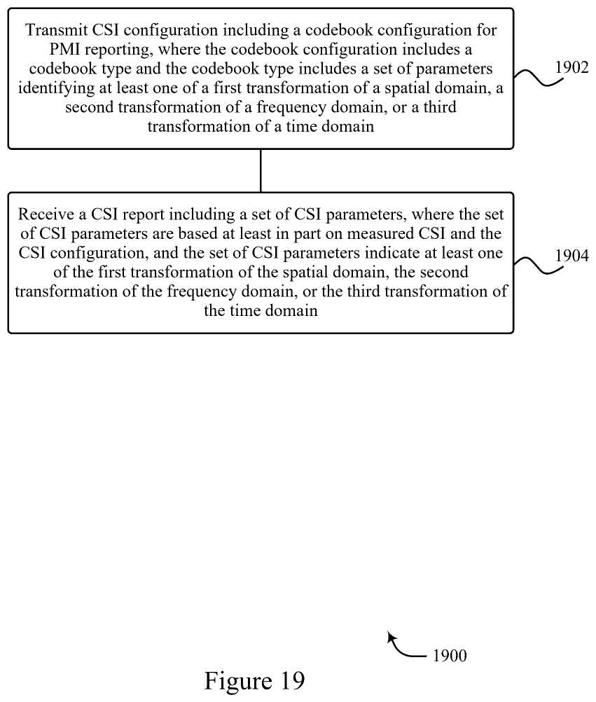

FIG. 19 illustrates a flowchart of a method 1900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1902, the method may include transmitting CSI configuration including a codebook configuration for PMI reporting, where the codebook configuration includes a codebook type and the codebook type includes a set of parameters identifying at least one of a first transformation of a spatial domain, a second transformation of a frequency domain, or a third transformation of a time domain. The operations of 1902 may be performed in accordance with examples as described herein. In some implementations, aspects of the operations of 1902 may be performed by an NE as described with reference to FIG. 17.

At 1904, the method may include receiving a CSI report including a set of CSI parameters, where the set of CSI parameters are based at least in part on measured CSI and the CSI configuration, and the set of CSI parameters indicate at least one of the first transformation of the spatial domain, the second transformation of the frequency domain, or the third transformation of the time domain. The operations of 1904 may be performed in accordance with examples as described herein. In some implementations, aspects of the operations of 1904 may be performed by an NE as described with reference to FIG. 17.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive channel state information (CSI) configuration including a codebook configuration for precoding matrix indicator (PMI) reporting, wherein the codebook configuration comprises a codebook type and the codebook type comprises a set of parameters identifying at least one of a first transformation of a spatial domain, a second transformation of a frequency domain, or a third transformation of a time domain;
measure CSI based at least in part on one or more received reference signals (RSs); and
transmit a CSI report comprising a set of CSI parameters, wherein the set of CSI parameters are based at least in part on the measured CSI and the CSI configuration, and the set of CSI parameters indicate at least one of the first transformation of the spatial domain, the second transformation of the frequency domain, or the third transformation of the time domain.

2. The UE of claim 1, wherein the first transformation is based on at least one of:
a first subset of columns of a first discrete Fourier transform (DFT) matrix;
a zero-forcing precoder that minimizes interference at the UE of a signal from a network equipment (NE) intended for another UE;
a Hadamard transformation;
a trivial selection of a subset of antenna ports; or
a transformation corresponding to distinct precoder coefficient values for individual antenna ports.

3. The UE of claim 1, wherein the second transformation is based on at least one of:
a second subset of columns of a second discrete Fourier transform (DFT) matrix;
a one-to-one transformation corresponding to a distinct precoder for each subband in the frequency domain;
a many-to-one transformation corresponding to a distinct precoder coefficient for each group of multiple groups of contiguous subbands in the frequency domain;
a trivial transformation corresponding to a wideband precoder coefficient that is common for all subbands in a bandwidth part;
a transformation based on a power-delay profile of a channel associated with the UE and a network equipment (NE);
a discrete cosine transform; or
a discrete wavelet transform.

4. The UE of claim 1, wherein the third transformation is based on at least one of:
a third subset of columns of a third discrete Fourier transform (DFT) matrix;
a one-to-one transformation corresponding to a distinct precoder coefficient for each slot in the time domain;
a many-to-one transformation corresponding to a distinct precoder coefficient for each group of multiple groups of contiguous slots;
a Bessel function-based transform;
a discrete cosine transform; or
a discrete wavelet transform.

5. The UE of claim 1, wherein the second transformation and the third transformation are implemented jointly as a single transformation.

6. The UE of claim 1, wherein the set of CSI parameters further comprise an indication of a set of precoder coefficients based on one or more of:
a first transformed domain based on the first transformation;
a second transformed domain based on the second transformation;
a third transformed domain based on the third transformation; or
an indication of a subset of precoder coefficients in the set of precoder coefficients with non-zero amplitude values.

7. The UE of claim 1, wherein the codebook type corresponds to a Fourier-based codebook type.

8. The UE of claim 7, wherein:
the first transformation is based on a first subset of columns of a first discrete Fourier transform (DFT) matrix; and
the second transformation is based on a combination of a second subset of columns of a second DFT matrix, wherein a distinct precoder for each group of multiple groups of contiguous subbands in the frequency domain is applied.

9. The UE of claim 7, wherein the third transformation is based on at least one of:
a third subset of columns of a third DFT matrix;
a one-to-one transformation corresponding to a distinct precoder for each slot in the time domain; or
a many-to-one transformation corresponding to a distinct precoder for each group of multiple groups of contiguous slots.

10. The UE of claim 1, wherein the codebook type corresponds to a singular value decomposition (SVD)-based codebook type.

11. The UE of claim 10, wherein:
the first transformation is based on a trivial transformation corresponding to a distinct precoder coefficient for individual antenna ports based on an SVD of a corresponding channel matrix;
the second transformation is based on a many-to-one transformation corresponding to a distinct precoder coefficient for each group of multiple groups of contiguous subbands in the frequency domain; and
the third transformation is based on a many-to-one transformation corresponding to a distinct precoder coefficient for each group of multiple groups of contiguous slots.

12. The UE of claim 1, wherein the one or more received RSs comprise non-zero power (NZP) CSI-RSs configured for channel measurement.

13. The UE of claim 1, wherein the codebook type corresponds to a covariance-based codebook type.

14. The UE of claim 13, wherein the covariance-based codebook type corresponds to one or more of interference or noise measured at the UE.

15. The UE of claim 14, wherein the one or more received RSs comprise one or more of:
non-zero power (NZP) CSI-RSs configured for interference measurement; or
zero power (ZP) CSI-RSs configured for interference measurement.

16. The UE of claim 13, wherein the set of CSI parameters comprise one or more of:
identification of a subset of precoder coefficients with non-zero amplitude values from a set of coefficients; or
amplitude values and phase values corresponding to the subset of precoder coefficients.

17. The UE of claim 13, wherein the covariance-based codebook type corresponds to a measure of an autocorrelation of a channel in one or more of the time domain, Doppler domain, the frequency domain, delay domain, or the spatial domain.

18. A processor for wireless communication, comprising:
at least one controller coupled with at least one memory and configured to cause the processor to:
receive channel state information (CSI) configuration including a codebook configuration for precoding matrix indicator (PMI) reporting, wherein the codebook configuration comprises a codebook type and the codebook type comprises a set of parameters identifying at least one of a first transformation of a spatial domain, a second transformation of a frequency domain, or a third transformation of a time domain;
measure CSI based at least in part on one or more received reference signals (RSs); and
transmit a CSI report comprising a set of CSI parameters, wherein the set of CSI parameters are based at least in part on the measured CSI and the CSI configuration, and the set of CSI parameters indicate at least one of the first transformation of the spatial domain, the second transformation of the frequency domain, or the third transformation of the time domain.

19. A method performed by a user equipment (UE), the method comprising:
receiving channel state information (CSI) configuration including a codebook configuration for precoding matrix indicator (PMI) reporting, wherein the codebook configuration comprises a codebook type and the codebook type comprises a set of parameters identifying at least one of a first transformation of a spatial domain, a second transformation of a frequency domain, or a third transformation of a time domain;
measuring CSI based at least in part on one or more received reference signals (RSs); and
transmitting a CSI report comprising a set of CSI parameters, wherein the set of CSI parameters are based at least in part on the measured CSI and the CSI configuration, and the set of CSI parameters indicate at least one of the first transformation of the spatial domain, the second transformation of the frequency domain, or the third transformation of the time domain.

20. A network equipment (NE) for wireless communication, comprising:
at least one memory; and
at least one processor coupled with the at least one memory and configured to cause the NE to:
transmit channel state information (CSI) configuration including a codebook configuration for precoding matrix indicator (PMI) reporting, wherein the codebook configuration comprises a codebook type and the codebook type comprises a set of parameters identifying at least one of a first transformation of a spatial domain, a second transformation of a frequency domain, or a third transformation of a time domain; and
receive a CSI report comprising a set of CSI parameters, wherein the set of CSI parameters are based at least in part on measured CSI and the CSI configuration, and the set of CSI parameters indicate at least one of the first transformation of the spatial domain, the second transformation of the frequency domain, or the third transformation of the time domain.
